(19) United States
(12) Patent Application Publication
(10) Pub. No.: US 2014/0032373 A1
(43) Pub. Date: Jan. 30, 2014

(54) HEURISTIC DATA ENTRY SYSTEM AND METHOD

(71) Applicant: Carl Christopher Tierney, Dallas, TX (US)

(72) Inventor: Carl Christopher Tierney, Dallas, TX (US)

(21) Appl. No.: 13/953,856

(22) Filed: Jul. 30, 2013

Related U.S. Application Data
(60) Provisional application No. 61/677,090, filed on Jul. 30, 2012.

(51) Int. Cl. G06F 17/30

(52) U.S. Cl. CPC G06F 17/30522
USPC 705/26.81; 705/39; 707/772

(57) ABSTRACT

A heuristic data entry system/method that integrates data entry search procedures and new data record entry functionality is disclosed. The system/method allows the data entry operator to enter one of more fields within a dialog menu representing a customer context. As these fields are entered a background process scans a customer database using a heuristic algorithm in an attempt to match the customer context against known customer records using a variety of matching algorithms incorporating non-tautological mapping functions. Customer records matched using these imprecise matching functions are then ranked by relevance and displayed as potential candidates for selection by the operator to complete the remaining customer context. The heuristic algorithms make no assumptions as to the accuracy the data operator entry or the customer record database, thus permitting potential matches between customer context and customer data records to occur with symmetrically non-dominant data accuracy assumptions.

### CROSS REFERENCE TO RELATED APPLICATIONS

This disclosure is a non-provisional conversion of, and thus claims priority to, U.S. Provisional Patent Application No. 61/677,090, filed Jul. 30, 2012, the entirety of which is incorporated herein by reference.

### PARTIAL WAIVER OF COPYRIGHT

All of the material in this patent application is subject to copyright protection under the copyright laws of the United States and of other countries. As of the first effective filing date of the present application, this material is protected as unpublished material.

However, permission to copy this material is hereby granted to the extent that the copyright owner has no objection to the facsimile reproduction by anyone of the patent documentation or patent disclosure, as it appears in the United States Patent and Trademark Office patent file or records, but otherwise reserves all copyright rights whatsoever.

### FIELD OF THE INVENTION

The present invention relates to systems and methods associated with computerized data entry/searching and generally includes graphical user interfaces (GUIs) utilized by data entry operators to affect data searches within and/or data entry into computerized databases. While not limitive of the teachings of the present invention, a typical application for this technology is in the field of customer information data entry and lookup.

### PRIOR ART AND BACKGROUND OF THE INVENTION

### Prior Art System Overview (0100)

The prior art system as it applies to a typical data entry operator environment is generally illustrated in FIG. 1 (0100). In this example, a data entry operator (0101) interacts with a graphical user interface (0102) operating in the context of a computer system (0103) running computer software read from a computer readable medium (0104). This data entry application environment may operate over a computer network (Internet, etc.) (0120) in conjunction with a web server (0130) running software read from a computer readable medium (0131) to implement website content (0132) or other user interface.

A common application in this context is that of a computerized interface that the operator (0101) manages to either enter or lookup customer data for the purposes of transacting business with a customer. This functionality generally bifurcates the functions associated with data entry for a new customer and customer lookup for a returning customer. As generally illustrated in FIG. 1 (0100), the data entry dialog (0141) interacts with a data entry processor (0142) to process new customers while the data search dialog (0151) interacts with a data search processor (0152) to manage lookup and processing of returning customers. A customer database (0160) reflects the storage of new customer data by the data entry processor (0142) and retrieval of stored customer data by the data search processor (0152).

It is notable in this context that the operator (0101) when confronted with a customer inquiry has no knowledge as to whether the customer is “new” or “returning” and therefore will normally perform a data search using the data search dialog (0151) with the associated data search processor (0152). If this search determines that the customer is “unknown” then the customer data is entered using the data entry dialog (0141) with the associated data entry processor (0142).

However, this typical scenario can be complicated by typographic errors generated by the operator (0101) and/or incorrect or not-exactly-matching data within the customer database (0160). Additionally, phonetic spelling by the operator (0101) when entering the data or misinterpretation of spelling by the operator can result in very minor errors in the resulting customer database (0160) that make subsequent matching by the data search processor (0152) impossible. As a result, the customer database (0160) is often filled with duplicate records for identical customers (with nearly identical database record contents). Despite this fact, searches of this database by the data search processor (0152) often result in “unknown” customer results due to minor discrepancies in the stored record data.

### Prior Art Method Overview (0200)

The prior art system above is generally associated with a prior art method that can be described as incorporating the following steps:
(1) Displaying a data search dialog (0201);
(2) Entering customer information in the data search dialog (0202);
(3) Searching for a match between the customer information and customer record information retrieved from a customer database (0203);
(4) If a match is found in the searching operation, proceeding to step (7) (0204);
(5) Displaying a data entry dialog and prompting an operator to enter customer information (0205);
(6) Storing the customer information in the customer database (0206);
(7) Displaying the customer record information in a dialog screen (0207);
(8) Processing transactions for the customer associated with the customer record information (0208);
(9) Proceeding to step (1);

Inefficiencies in this process exist mainly between the data entry and data search dialogs as well as the fact that the matching function in step (3) may return false positive/negative matches that can make identification of a given customer (as it relates to the customer database) difficult if not impossible.

### Deficiencies in the Prior Art

The prior art as detailed above suffers from the following deficiencies:
Dialog screens associated with customer data entry are managed by data entry operators that are imperfect, resulting in data entry errors migrating to customer databases.
Data entry operators make mistakes in data entry operations and as a result direct searching techniques applied to this data will not yield a match in a given customer database.
Conventional customer data entry screens and customer search screens appear on different dialogs, resulting in wasted operator time in traversing between one dialog screen and another when attempting to identify a given customer for a particular computerized transaction.

While some of the prior art may teach some solutions to several of these problems, the core increasing productivity within data entry systems have not been addressed by the prior art.

### OBJECTIVES OF THE INVENTION

Accordingly, the objectives of the present invention are (among others) to circumvent the deficiencies in the prior art and affect the following objectives:
(1) Provide for a data entry system and method that allows for integration of the data entry and searching operations.
(2) Provide for a data entry system and method that heuristically adapts to operator data entry in real-time to permit more accurate customer database searching.
(3) Provide for a data entry system and method that eliminates multi-dialog displays for data entry and search functions.
(4) Provide for a data entry system and method that incorporates generic filling of dialog fields based on ranked search results.

While these objectives should not be understood to limit the teachings of the present invention, in general these objectives are achieved in part or in whole by the disclosed invention that is discussed in the following sections. One skilled in the art will no doubt be able to select aspects of the present invention as disclosed to affect any combination of the objectives described above.

### BRIEF SUMMARY OF THE INVENTION

The present invention describes a system and method for facilitating data entry and/or database search where neither the data entered nor the database searched has absolute accuracy confidence. As typically applied to a wide variety of manual data entry applications, the disclosed system/method incorporates a heuristic processor that enables data gathered from one or more fields in a data entry screen dialog to be matched/searched against an arbitrary database of corresponding information. This enables location of existing database records as well as the creation of new database records from a single data entry screen without the need for a change in operator data entry context. By eliminating the need for operator data context switches between a variety of data entry screens and applying “fuzzy” non-tautological matching criterion to operator data entry fields, the disclosed system/method improves the overall productivity and accuracy of manual data entry operations.

### BRIEF DESCRIPTION OF THE DRAWINGS

For a fuller understanding of the advantages provided by the invention, reference should be made to the following detailed description together with the accompanying drawings wherein:

FIG. 1 illustrates a prior art data entry system architecture;

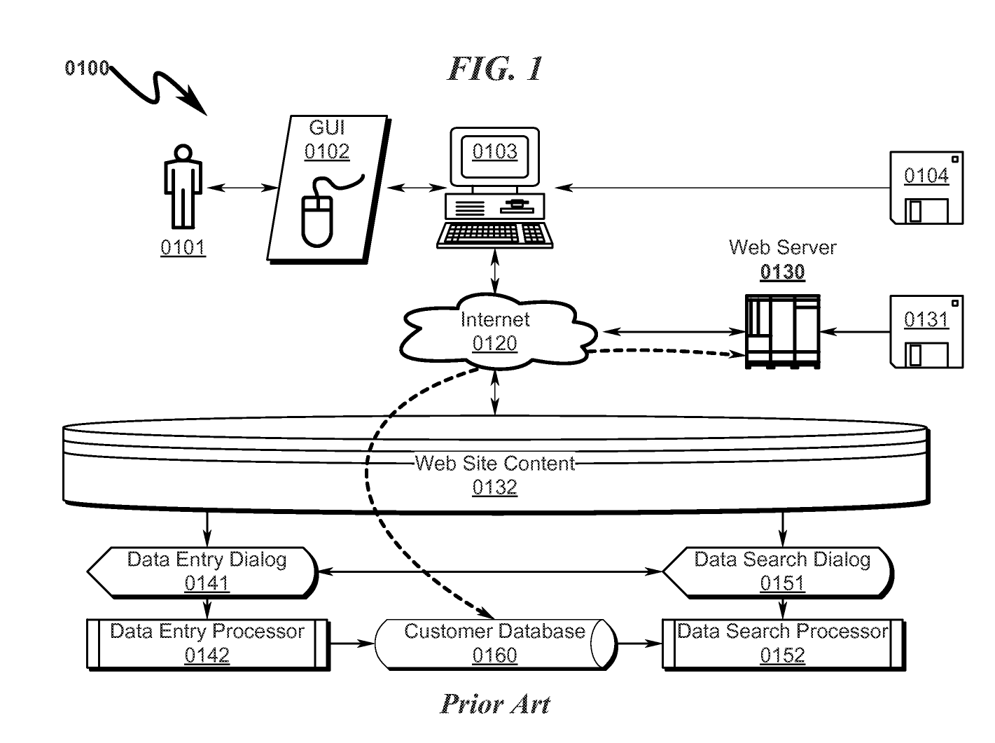

FIG. 2 illustrates a prior art data entry method architecture;

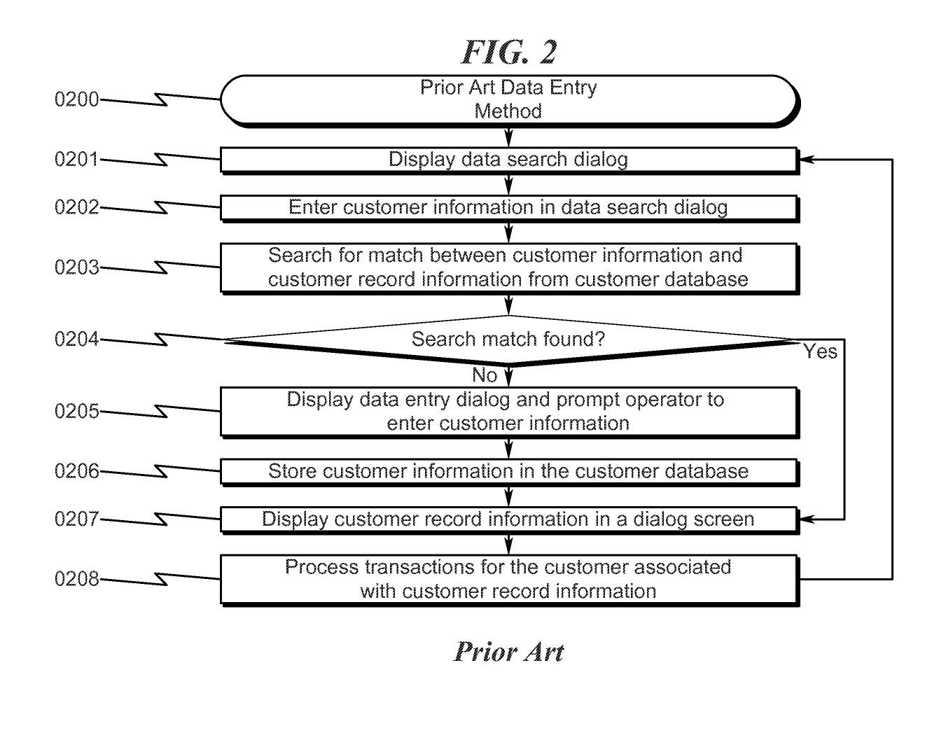

FIG. 3 illustrates a preferred exemplary system embodiment of the present invention;

FIG. 4 illustrates a preferred exemplary method embodiment of the present invention;

FIG. 5 illustrates a preferred exemplary system embodiment of the present invention used within a check processing data entry application;

FIG. 6 illustrates a preferred exemplary system embodiment of the present invention used within a customer order processing data entry application;

FIG. 7 illustrates a prior art data entry application as typically used in the context of a web-based product ordering system;

FIG. 8 illustrates a preferred exemplary system embodiment of the present invention used within a single-screen web product order placement application;

FIG. 9 illustrates a preferred exemplary data entry dialog associated with a preferred system embodiment of the present invention used within the context of a customer data entry application;

FIG. 10 illustrates an exemplary heuristic data entry scenario associated with a data dialog in a preferred system embodiment of the present invention as used within a customer data entry application;

FIG. 11 illustrates an exemplary heuristic data entry scenario associated with a data dialog in a preferred system embodiment of the present invention as used within a customer data entry application;

FIG. 12 illustrates an exemplary heuristic data entry scenario associated with a data dialog in a preferred system embodiment of the present invention as used within a customer data entry application;

FIG. 13 illustrates an exemplary heuristic data entry scenario associated with a data dialog in a preferred system embodiment of the present invention as used within a customer data entry application;

FIG. 14 illustrates an exemplary heuristic data entry scenario associated with a data dialog in a preferred system embodiment of the present invention as used within a customer data entry application;

FIG. 15 illustrates an exemplary computerized transaction process activation scenario associated with a data dialog in a preferred system embodiment of the present invention as used within a customer data entry application;

FIG. 16 illustrates an exemplary heuristic data entry scenario associated with a data dialog in a preferred system embodiment of the present invention as used within a customer data entry application incorporating freeform customer information data entry;

FIG. 17 illustrates a flowchart implementing an exemplary embodiment of the present invention as applied to a heuristic data entry method;

FIG. 18 illustrates a flowchart implementing an exemplary embodiment of a data field filling method useful in some preferred embodiments of the present invention;

FIG. 19 illustrates a flowchart implementing an exemplary embodiment of a data entry mapping correlator method useful in some preferred embodiments of the present invention;

FIG. 20 illustrates a flowchart implementing an exemplary embodiment of a data entry mapping correlation heuristic method useful in some preferred embodiments of the present invention;

FIG. 21 illustrates an exemplary embodiment of a heuristic search matching function useful in some preferred embodiments of the present invention;

FIG. 22 illustrates data flow associated with an exemplary crosspoint equivalence detector useful in some preferred embodiments of the present invention;

FIG. 23 illustrates an exemplary flowchart describing a crosspoint equivalence detector method useful in implementing some preferred embodiments of the present invention;

FIG. 24 illustrates a system block diagram depicting an abstraction of the present invention.

### DETAILED DESCRIPTION

While this invention is susceptible of embodiment in many different forms, there is shown in the drawings and will herein be described in detailed preferred embodiment of the invention with the understanding that the present disclosure is to be considered as an exemplification of the principles of the invention and is not intended to limit the broad aspect of the invention to the embodiment illustrated.

The numerous innovative teachings of the present application will be described with particular reference to the presently preferred embodiment, wherein these innovative teachings are advantageously applied to the particular problems of a HEURISTIC DATA ENTRY SYSTEM AND METHOD. However, it should be understood that this embodiment is only one example of the many advantageous uses of the innovative teachings herein. In general, statements made in the specification of the present application do not necessarily limit any of the various claimed inventions. Moreover, some statements may apply to some inventive features but not to others.

### Customer Data Context Not Limitive

While the present invention may be described in terms of a customer data entry/search scenario, the scope of the present invention is not limited to this specific application. Thus, the terms “customer context data fields” and their associated dialog may be equally applied to any scenario in which a multiplicity of data entry fields must be entered and which may be correlated with one or more corresponding record data fields contained within a master (customer) database. This abstraction also applies to terminology describing the customer database, as the present invention makes no limitation on the exact nature or contents of the customer database.

### Internet Communication Not Limitive

The present invention anticipates that a wide range of communication methodologies may be utilized to affect a specific implementation of the present invention. While the present invention specifically anticipates that the use of the Internet for most applications, the present invention makes no limitation on the type of communication technology or computer networking that may be used. Thus, the term “computer network” and/or “Internet” are to be given the broadest possible definitions within the scope of the present invention.

### Heuristic Non-Tautological Mapping

The present invention generally approaches the matching search function between operator data entry and database records in a manner that assumes neither the operator data entry is totally correct nor that the customer database being searched is totally correct. Within this context the search pattern logic is bi-directionally “fuzzy” in that data abnormalities are expected to be found in both the search pattern (customer content data fields) and the searched data target (customer database records). Within this context there is the potential for any given data entry element to match multiple customer data records, but also the potential for a given customer data record (and its contents) to match multiple data entry elements. Given that tautological maps may be defined as having “one-to-one and onto” mapping properties, this search matching function is described herein as non-tautological. Given that accuracy levels for both the data entry and the customer database are not assumed, the system/method may also be described as incorporating symmetric non-dominant data accuracy assumptions.

The mapping function is also described herein as “heuristic” because it may learn from the behavior of the data entry operator to modify its search/matching capabilities to adapt for and correct a wide variety of data entry errors, including but not limited to the following:
misspelling (i.e., “misstake”→“mistake”);
synonyms remapping (i.e., “hon”→“hawn”);
mispronunciations (i.e., “honor”→“owner”);
key swapping (i.e., “mispalced”→“misplaced”);
key insertion (i.e., “misplasced”→“misplaced”);
key replication (i.e., “missplaced”→“misplaced”);
key omission (i.e., “miplaced”→“misplaced”);
key shift offsets (i.e., “miaplaced”, “misplaced”, “miwplaced”, “mieplaced”, “midplaced”, “mixplaced”, “misplaced”→“misplaced”) as they generally relate to QUERTY keyboard single-key offsets; and
home key offsets (misplacement of the left and/or right hand over incorrect home keys on a QUERTY keyboard).
   One skilled in the art will recognize that this list of heuristics is non-exhaustive.

### System Overview (0300)

### General Structure

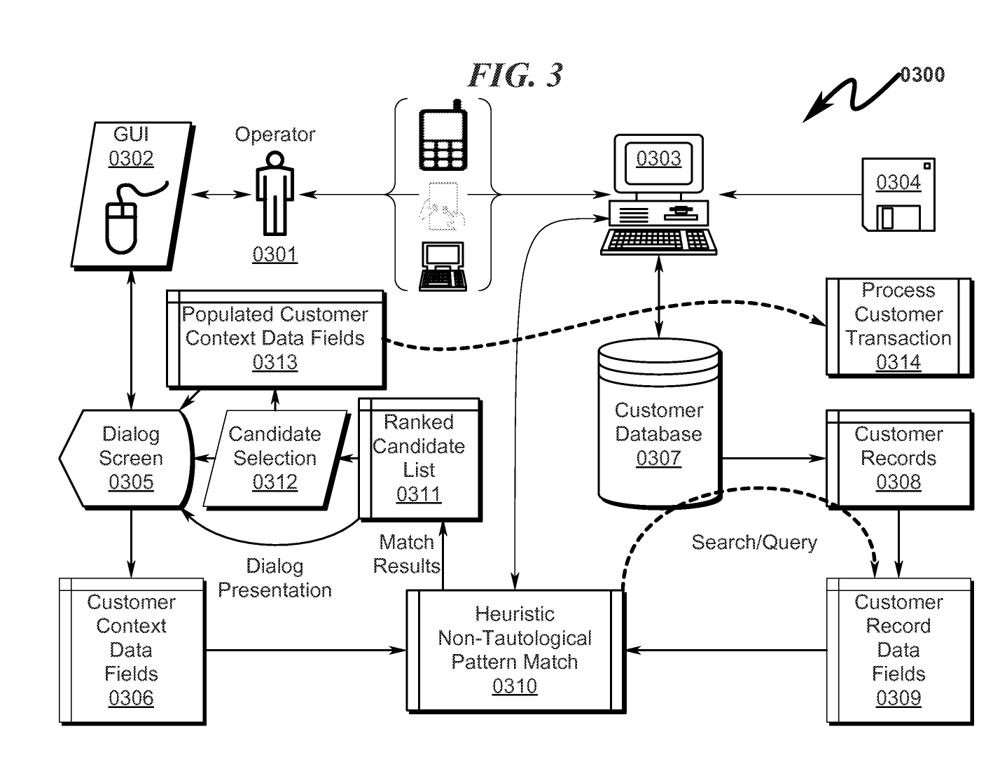

The present invention in a system embodiment may be broadly described as depicted in FIG. 3 (0300) wherein the system application context deals with operator data entry and customer record lookup operations using web-based electronic commerce and the like. Within this context the data entry operator (0301) interacts with a graphical user interface (0302) running under control of a computer system (0303) executing machine instructions read from a computer readable medium (0304). The GUI (0302) displays a data entry dialog screen (0305) incorporating customer context data fields (0306) that may include name, address, contact information, account numbers, etc. These customer context data fields (0306) may include errors and omissions as entered by the operator (0301) and thus include a search context for the particular customer associated with the entered data (0306).

Customers associated with this general procedure have their profile information stored in a customer database (0307) that further comprises individual customer records (0308) that further comprise individual customer record data fields (0309). These customer record data fields (0309) generally correspond to the partial information in the customer context data fields (0306), although in some circumstances this information may be stored in a translated or augmented form, such as the case with passwords, aliases, maiden names, alternate telephone numbers and/or addresses, etc.

The partial customer data (0306) as it is entered is continuously used as a search criterion by a heuristic non-tautological pattern matching process (0310) to determine if there are any potential matches between the entered partial customer data (0306) and that found by the heuristic search (0310) of the customer database (0307). If any matches are found, a ranked candidate list (0311) is generated and displayed on the data entry dialog screen (0305) for review by the operator (0301). Selection (0312) of one of the members of the ranked candidate list as displayed results in population (0313) of the customer context data fields in the data entry dialog screen in preparation for subsequent processing of the customer transaction (0314).

### Pattern Matching Triggers

The “continuous” nature of the heuristic non-tautological pattern matching (0310) used in this system can have many variants. Depending on system performance characteristics, the search can be performed in a wide variety of ways, including but not limited to:
after every keystroke, word, and/or phrase;
initiated on a time-driven periodic interval;
initiated based on the availability of computing resources;
initiated based on the availability of network bandwidth; and/or
manually initiated by the operator (0301).

Within this context the resulting ranked candidate list (0311) that is displayed for selection (0312) may be configured in some circumstances to populate the data entry dialog screen (0305) with a member of the ranked candidate list when a mouse or other cursor is drawn over the particular ranked candidate list member.

### Structural Summary

The present invention system anticipates a wide variety of variations in the basic theme of construction, but can be generalized as a heuristic data entry system comprising:
(a) data entry interface (0302);
(b) customer database (0307); and
(c) record matching processor (0310);
wherein
the data entry interface (0302) displays a data entry dialog screen (0305), the data entry dialog screen (0305) comprising a series of customer context data fields (0306);
the data entry interface (0302) permits operator (0301) data entry of customer data into one or more of the customer context data fields (0306) within the data entry dialog screen (0305);
the customer database comprises (0307) customer records (0308) comprising customer record data fields (0309) associated with the customer context data fields (0306);
the record matching processor (0310) continuously matches the customer context data fields (0306) to the customer record data fields (0309) using a heuristic non-tautological mapping algorithm during the operator data entry to produce a set of potential selection candidates in real-time;
the potential selection candidates are ranked to produce a ranked candidate list (0311);
the ranked candidate list (0311) is displayed on the data entry dialog screen (0305);
the data entry interface (0302) is configured to permit operator selection (0312) of a member of the ranked candidate list; and
the operator selection executes a population (0313) of the customer context data fields with the customer record data fields.
   This general system summary may be augmented by the various elements described herein to produce a wide variety of invention embodiments consistent with this overall design description.

One skilled in the art will recognize that the “customer database” (0307) may comprise any database in which customer context data field may be matched using the pattern matching processor (0310), and that the customer context data fields (0306) may comprise any form of operator data entry associated with a particular application context. Thus, the concepts of “customer database” and “customer context data fields” should be broadly construed within this context when reading this specification and associated invention claims scope.

### Method Overview (0400)

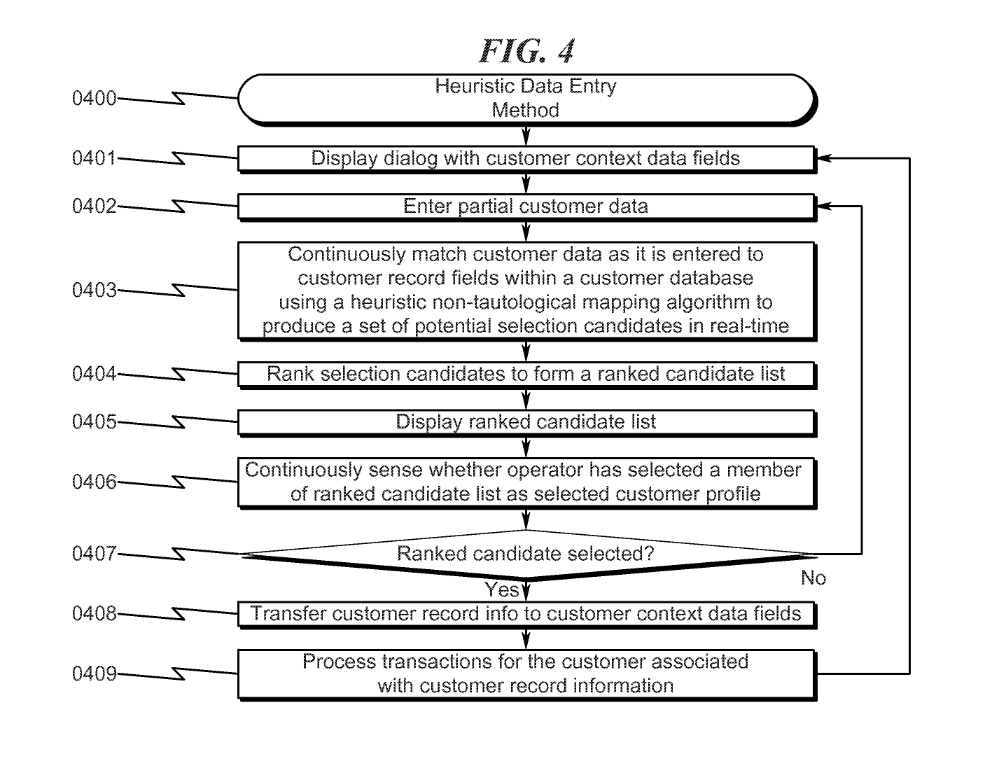

The present invention in a method embodiment may be generally described by the flowchart of FIG. 4 (0400), wherein the heuristic data entry method comprises the following steps:
(1) displaying a data entry dialog screen comprising customer data fields on a data entry interface (0401);
(2) accepting partial customer data as input within the customer data fields on the data entry interface (0402);
(3) continuously matching the customer data fields as the partial customer data is entered against customer record fields within a customer database using a heuristic non-tautological mapping algorithm to produce a set of potential selection candidates in real-time (0403);
(4) ranking the potential selection candidates to form a ranked candidate list (0404);
(5) displaying the ranked candidate list on the data entry dialog screen (0405);
(6) continuously sensing whether a member of the ranked candidate list has been selected via the data entry interface (0406);
(7) if the member has not been selected, proceeding to step (2) (0407);
(8) transferring the customer record fields to the customer data fields in the data entry dialog screen (0408); and
(9) processing a computerized transaction for the customer associated with the customer data fields and proceeding to step (1) (0409);
wherein
the steps are performed by one or more computer systems executing software retrieved from a computer readable medium.
   This general method may be modified heavily depending on a number of factors, with rearrangement and/or addition/deletion of steps anticipated by the scope of the present invention. Integration of this and other preferred exemplary embodiment methods in conjunction with a variety of preferred exemplary embodiment systems described herein is anticipated by the overall scope of the present invention.

### Exemplary Application

### Check Processing (0500)

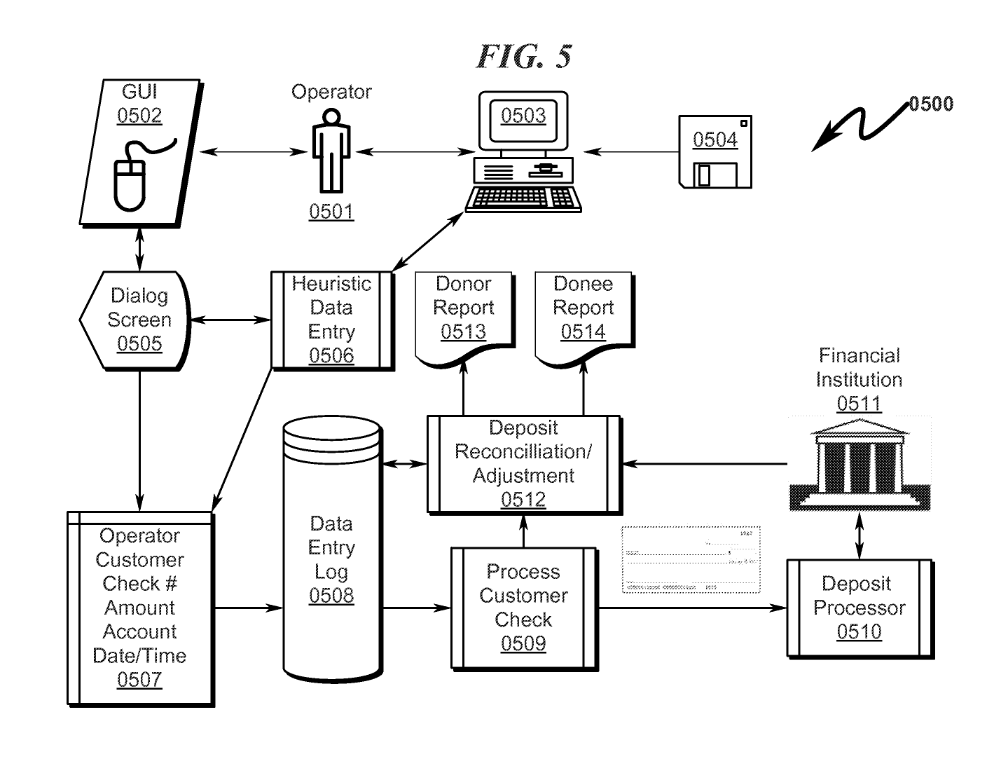

While the present invention may be used in a wide variety of applications, one preferred system embodiment has advantageous application in the area of check processing. As generally illustrated in FIG. 5 (0500), a typical system implementing a check processing function uses a data entry operator (0501) that receives checks that are to be associated with a given customer account. The data entry operator enters the check information using a GUI (0502) running under control of a computer system (0503) that executes machine instructions retrieved from a computer readable medium (0504).

The GUI (0502) displays a data entry dialog screen (0505) that accepts operator data under control of a heuristic data entry process (as described herein) (0506) to permit the operator (0501) to quickly associate the information on the check with a given customer (either previously known or new). Given the imperfections in both the check writer and the operator, the heuristic data entry process (0506) permits these imperfections to be corrected/ignored and the proper customer to be associated with the check processed by the data entry operator (0501).

The result of the heuristic data entry process is a list of corrected information regarding the check and the associated customer identification (0507) that is then logged (0508) and used by a check processing function (0509) that ensures the check is properly deposited (0510) in a financial institution (0511) and also that reconciliation of this deposit along with any account adjustments (0512) are made to the logged deposit transaction (0508). Once deposit reconciliation and/or adjustment (0512) is completed, donor reports (0513) and/or donee reports (0514) can be generated to ensure that the involved parties are both made aware of the check deposit. These reports (0513, 0514) are especially important for non-profit organizations that must keep track of customer donations and also for the donors that contribute to these organizations as the donor reports (0513) are required for tax accounting purposes.

### Exemplary Application

### Customer Order Processing (0600)

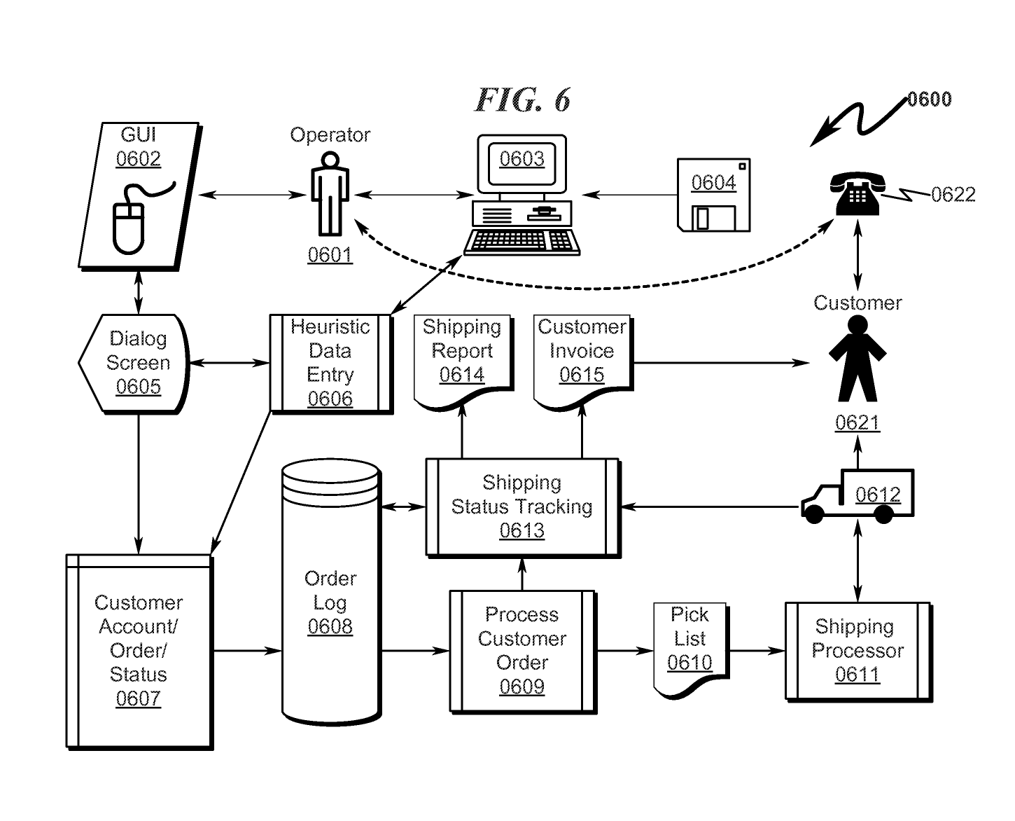

Another preferred system embodiment has advantageous application in the area of customer order processing. As generally illustrated in FIG. 6 (0600), a typical system implementing a customer order processing function in which a customer (0621) communicates using a communication means (0622) with a data entry operator (0601) that receives product/service order requests that are to be associated with a given customer account. The data entry operator enters the customer order information using a GUI (0602) running under control of a computer system (0603) that executes machine instructions retrieved from a computer readable medium (0604).

The GUI (0602) displays a data entry dialog screen (0605) that accepts operator data under control of a heuristic data entry process (as described herein) (0606) to permit the operator (0601) to quickly associate the information for the customer order with a given customer (either previously known or new). Given the imperfections in both the customer (0621), communications means (0622), and the operator, the heuristic data entry process (0606) permits these imperfections to be corrected/ignored and the proper customer to be associated with the customer order processed by the data entry operator (0601).

The result of the heuristic data entry process is a list of corrected information regarding the customer order and the associated customer identification (0607) that is then logged (0608) and used by a customer order processing function (0609) that ensures the customer order is staged for delivery (0610) using a suitable shipping processor (0611) and associated delivery means (0612). Reconciliation/tracking of the shipping request (0613) along with any account adjustments are made to the order log database (0608). Once shipping (0612) is completed, shipping reports (0614) and/or customer invoices (0615) can be generated to ensure that the involved parties are both made aware of the satisfaction of the customer order. Note that while the communications means (0622) is illustrated in this example as a telephone, it could equivalently be some other form of communication means such as e-mail, fax, etc.

### Exemplary Application

### Customer Web Shopping

### Prior Art Comparison (0700)

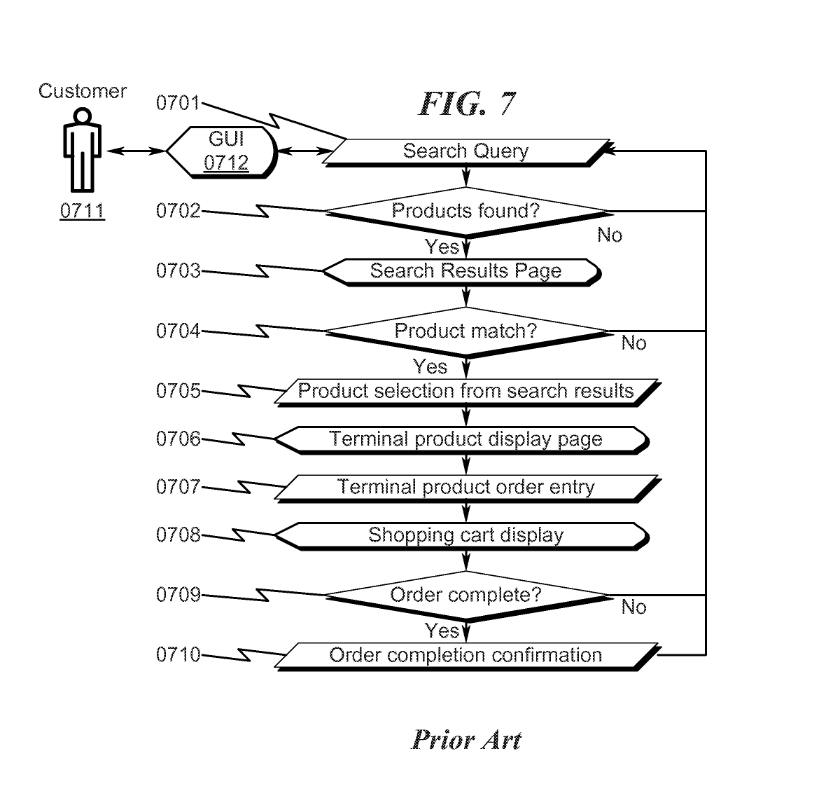

Yet another preferred system embodiment has advantageous application in the area of customer web shopping. To fully understand the advantages of the present invention as implemented in this application context it is useful to first review the prior art customer web shopping experience as generally depicted in the flowchart of FIG. 7 (0700). As generally illustrated in FIG. 7 (0700), a conventional customer web processing system permits a customer (0711) to interact with a GUI (0712) that communicates with a web server (not shown) to affect the following procedural steps:
(1) The customer enters a search query in the web browser (0701);
(2) If no products matching the search are found, control is passed to step (1) (0702);
(3) A resulting search results page is displayed, indicating a variety of matches associated with the customer search text (0703);
(4) After review of the search page results by the customer, if no products match the customer's desired search criterion, the customer returns to step (1) for additional search data entry (0704);
(5) The customer selects a given product selection from the search results page (0705);
(6) A terminal product page indicating a given product is displayed for the customer to review (0706);
(7) After review, the customer selects the terminal product for order entry (0707);
(8) The ordered product is added to the shopping cart list and the shopping cart list is displayed for customer review (0708);
(9) The customer determines if the order is complete, and if not, control is passed to step (1) for additional search inquiries and product ordering (0709); and
(10) Order completion confirmation is given to the customer and control passes to step (1) for additional search inquiries and product ordering (0710).
   This system suffers from a significant efficiency deficiency in that in many circumstances the search inquiry in step (1) must be repeated numerous times in order to “find” the product that the customer is interested in purchasing. Furthermore, the customer must often “drill down” into the ranked product selection pages (steps (5) and (6)) in order to determine if the “terminal” product is in fact the one the customer is interested in purchasing. This back-and-forth search-and-display technique fails to use any knowledge from previous purchases and also fails to efficiently use the input from the customer to tailor the searched results. Furthermore, no heuristics associated with the selection patterns of the consumer are used in this process—it is completely stateless and devoid of historical context.

### Present Invention Web-Based Order Placement Embodiment (0800)

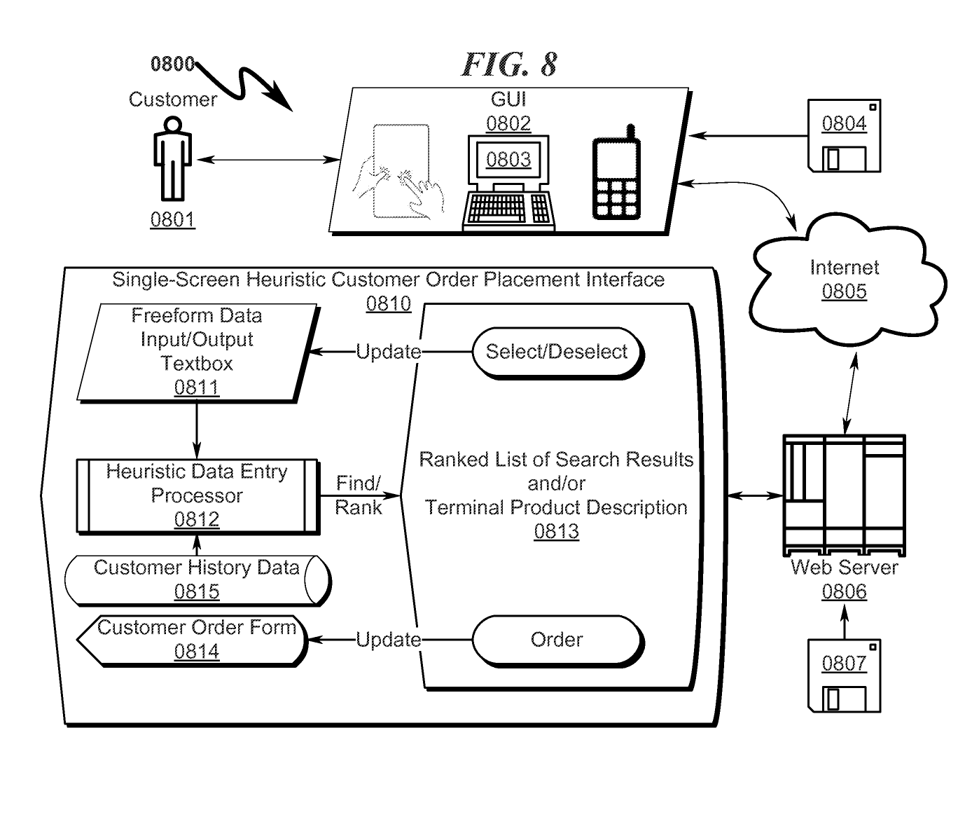

In contrast, the heuristic data entry system/method taught by the present invention as depicted in FIG. 8 (0800) and applied to a customer web-based electronic commerce order placement interface integrates the purchasing environment to avoid the inefficiencies present in the prior art. As generally illustrated in FIG. 8 (0800), the customer (0801) in this context interacts with a GUI (0802) that may comprise a plethora of various wired and wireless data terminal interfaces (0803) each executing machine instructions read from a computer readable medium (0804). The GUI (0802) (and associated data terminal interfaces (0803)) interact via a communication network (Internet, etc.) (0805) with a web server (0806) that executes machine instructions read from a computer readable medium (0807). This web server (0806) is responsible for displaying and maintaining a single-screen heuristic customer order placement interface (0810) that is the heart of the customer product ordering user experience.

The single-screen heuristic customer order placement interface (0810) attempts to integrate heuristic search, display results, and customer ordering within a single user experience in the following fashion. The customer interacts with a freeform data input/output textbox (0811) on the interface (0810) to enter search parameters for a desired product purchase. This freeform input (0811) is then processed by the heuristic data entry processor (0812) to find and rank potential product matches that are then displayed as a ranked list of search results and/or a terminal product description (0813) within the same overall user interface dialog (0810). Selection or deselection of any of the ranked elements in this display area (0813) results in updating of the freeform data input/output textbox (0811) and reprocessing of this information by the heuristic data entry processor (0812) to update the product description display (0813). At any time the customer may activate a product order resulting in a customer order form (0814) being updated within the same overall product order placement interface (0810). As generally illustrated in this diagram, the heuristic data entry processor (0812) may make use of a database (0815) comprising historical customer purchases to make recurring purchases easier to identify and repeat.

A key benefit to this order placement architecture is the integration of search input (0811), heuristic data entry processing (0812), ranked search results output (0813), and customer shopping cart contents on a singular order placement interface (0810). Rather than switching between a variety of web page displays during the shopping experience, the customer (0801) remains in a single screen interface (0810) throughout the entire process. Additionally, the use of a heuristic data entry processor in this context ensures that the customer need not be exact in their knowledge of the exact phrasing, spelling, or typing of a particular product description. This ability to apply “fuzzy” matching logic between the needs of the customer and the product catalog of a given supplier make this interface (0810) superior to systems that either perform phrase pattern matching or force the customer to navigate a hierarchy of product descriptions and categories in order to find a particular product.

### Exemplary User Dialog Interface (0900-1600)

### Overview

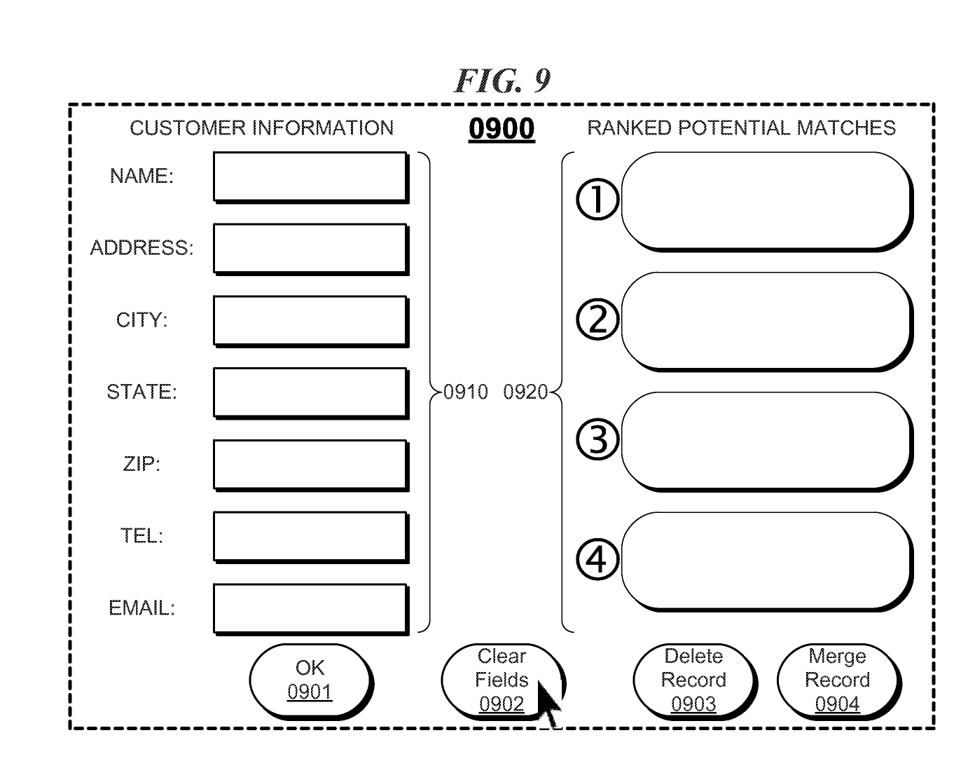

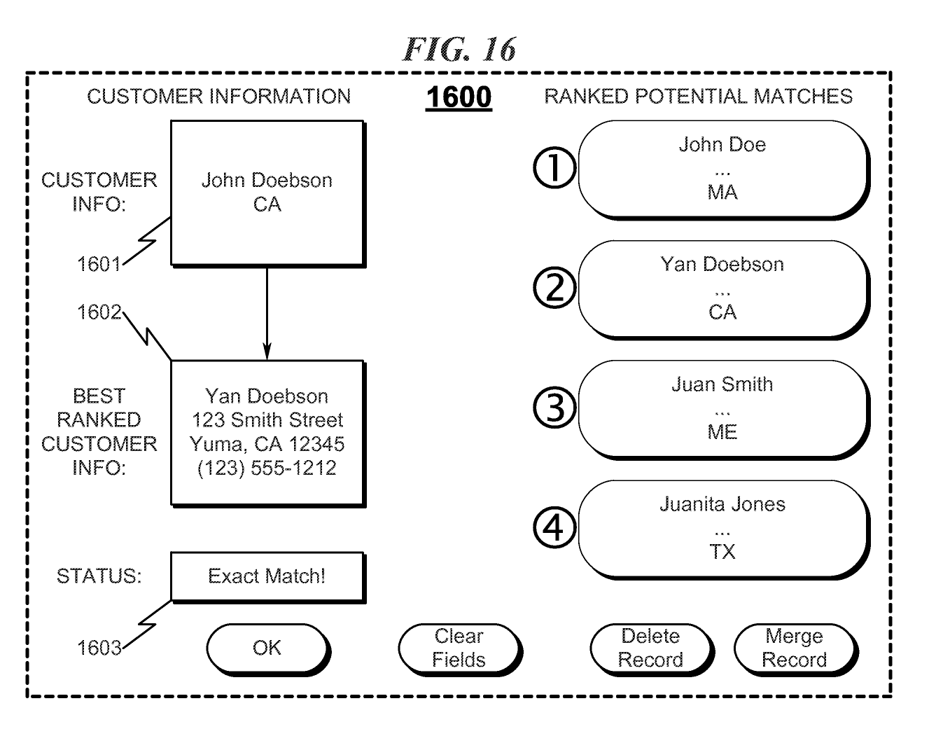

While the concept of a customer data entry dialog may take many forms, an exemplary embodiment of this data entry dialog with exemplary data entry input sequences is depicted in FIG. 9 (0900)—FIG. 16 (1600), wherein the customer context data fields (0910) in this scenario comprise standard contact information and the ranked candidate list (0920) are depicted schematically in this example. Within this exemplary application context, the customer data entry dialog screen may include one or more of the following buttons or activity triggers:
an OK (0901) icon button (accepting the customer context data fields and proceeding to computerized processing of the customer associated with the customer context data fields);
a CLEAR FIELDS (0902) icon button (clearing all customer context data fields and preparing for a new data entry cycle);
a DELETE RECORD (0903) icon button (deleting the database record associated with the current customer context data field);
a MERGE RECORD (0904) icon button (merging two distinct database records as selected on the display to eliminate duplicate data records for a given customer).
   One skilled in the art will recognize that this list is exemplary and non-exhaustive.

### Exemplary Heuristic Data Entry Sequence (1000-1200)

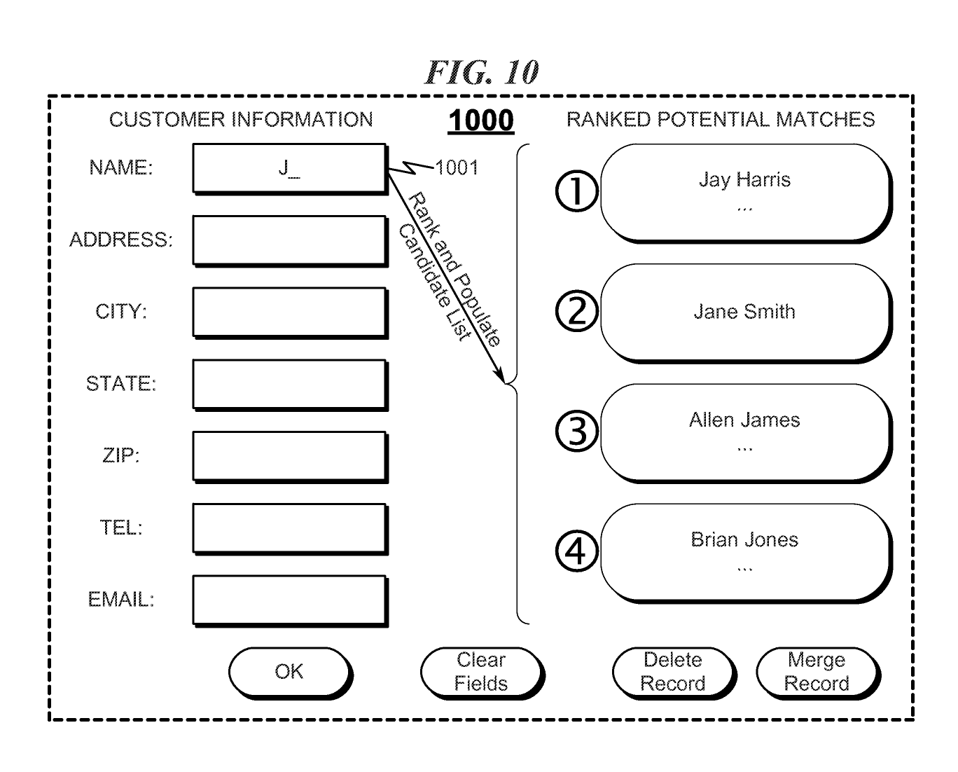

An exemplary operation of the heuristic nature of the present invention as applied to a typical data entry sequence begins in FIG. 10 (1000), wherein the data entry operator initially enters “J” into the “NAME” field (1001) of the dialog screen. In this example each keystroke triggers a heuristic search through the customer database to find potential matches for the desired customer. This search results in a ranked list of results that are displayed in rank order form in the dialog screen. Here it can be observed that the initial “J” entry may match first and/or last names as part of the search heuristic.

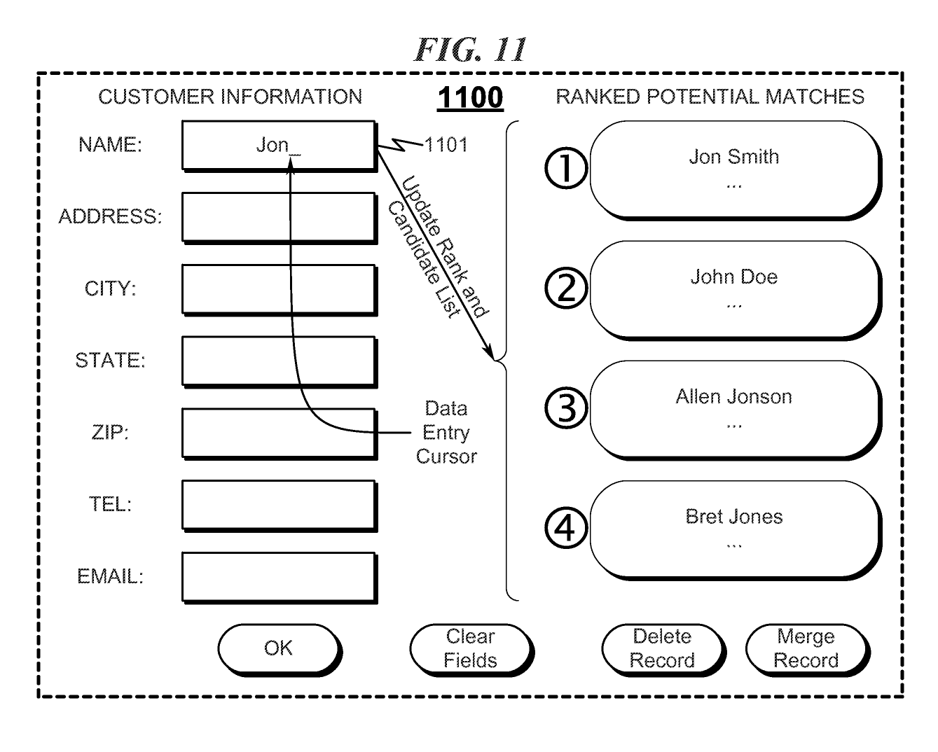

As generally depicted in FIG. 11 (1100), additional input (“JON”) by the data entry operator results in an updated list of ranked search results. This updating procedure occurs dynamically as the screen dialog data is entered by the operator.

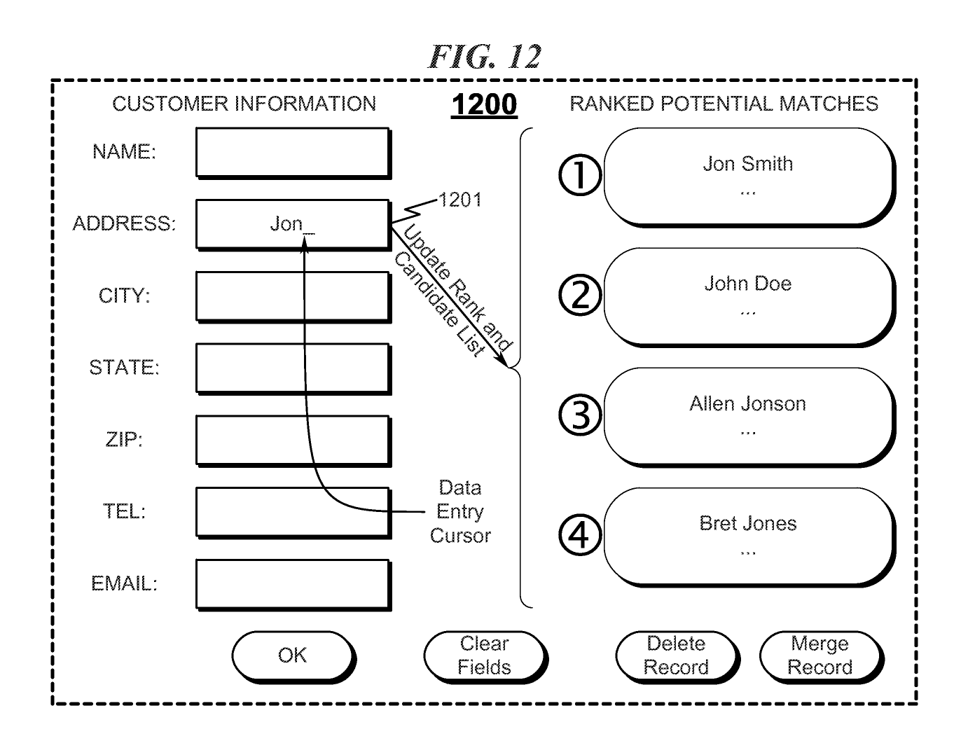

As depicted in FIG. 12 (1200), this same search result may be obtained by entering data in other areas (1201) of the customer context data fields. What this simulated screen illustrates is that the individual fields within the customer context data fields are not necessarily linked with individual data fields within the customer database. This linkage can be present, but is not necessarily the strong linkage present in prior art search/matching techniques. For example, each customer context data field has an affinity for the corresponding data field in the customer database, but is not necessarily limited to that field in the customer database.

### Heuristic Substitution (1300)

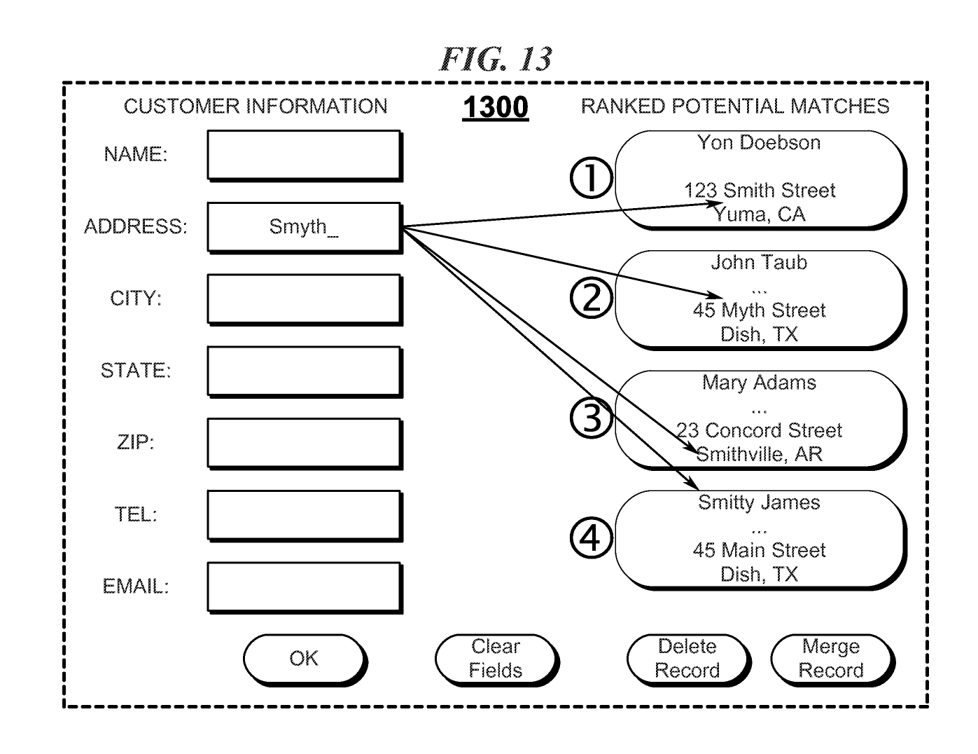

As detailed below, the heuristic data entry algorithms used by the present invention may utilize a number of substitutions in conjunction with numerous dictionaries of known words in a variety of contexts to enable the search matching functionality of the data entry operation to present plausible solutions to a given operator data entry search even in situations where the entered data is imprecise. An example of this in operation is depicted in FIG. 13 (1300), wherein the operator has incorrectly entered the street identifier as “Smyth.” The heuristic matching algorithm has matched this to “Smith,” “Myth,” as well as variants associated with the city and variants of the customer name. While the context of the matching function is taken into account, the pattern matching may extend across data field boundaries that are normally not crossed by conventional pattern matching algorithms used by the prior art. Thus, the weight factors in these circumstances may differ slightly from those used within the field of strict data field pattern matches, but the ability for the operator to enter relevant information in any field permits a significant improvement in overall data entry operator productivity. A reduction of operator keystrokes necessary to affect a given search pattern solution results in significantly faster search solutions and less overall operator fatigue.

### Ranked Candidate List Selection (1400)

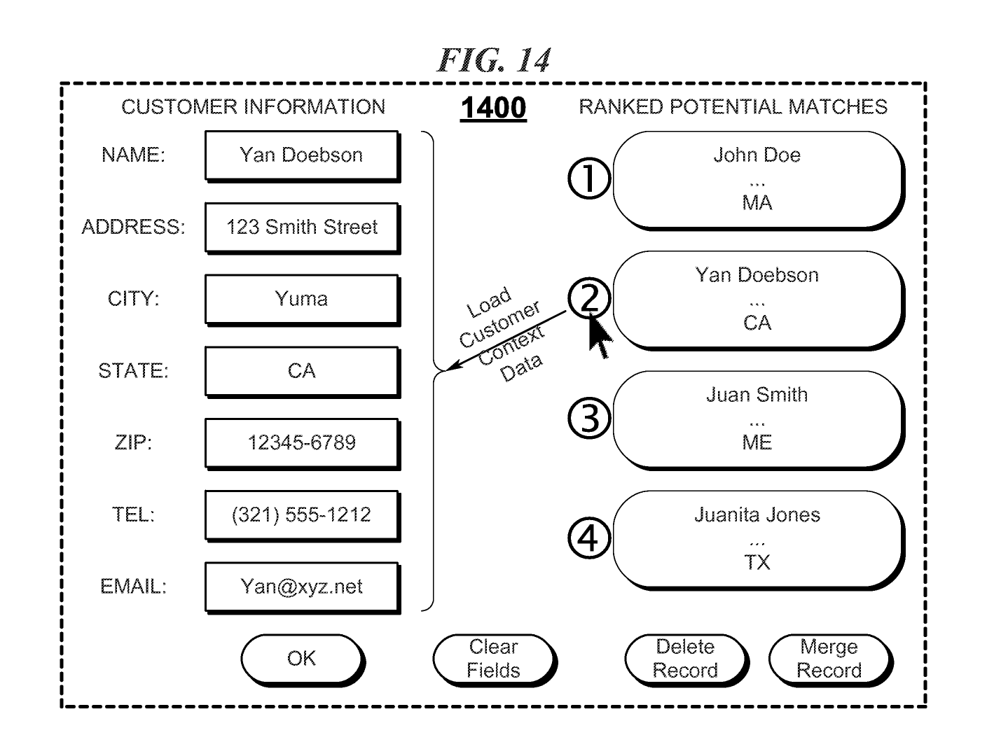

Once the potential selection candidate list is established and displayed on the customer data entry dialog screen, the data entry operator may select one of the ranked list entries to fill the customer context data fields as generally indicated in FIG. 14 (1400). Here the selection of the ranked entry automatically fills the customer context data fields and links the display dialog to the customer index within the customer database of the customer associated with the ranked selection candidate.

### Transaction Processing Completion (1500)

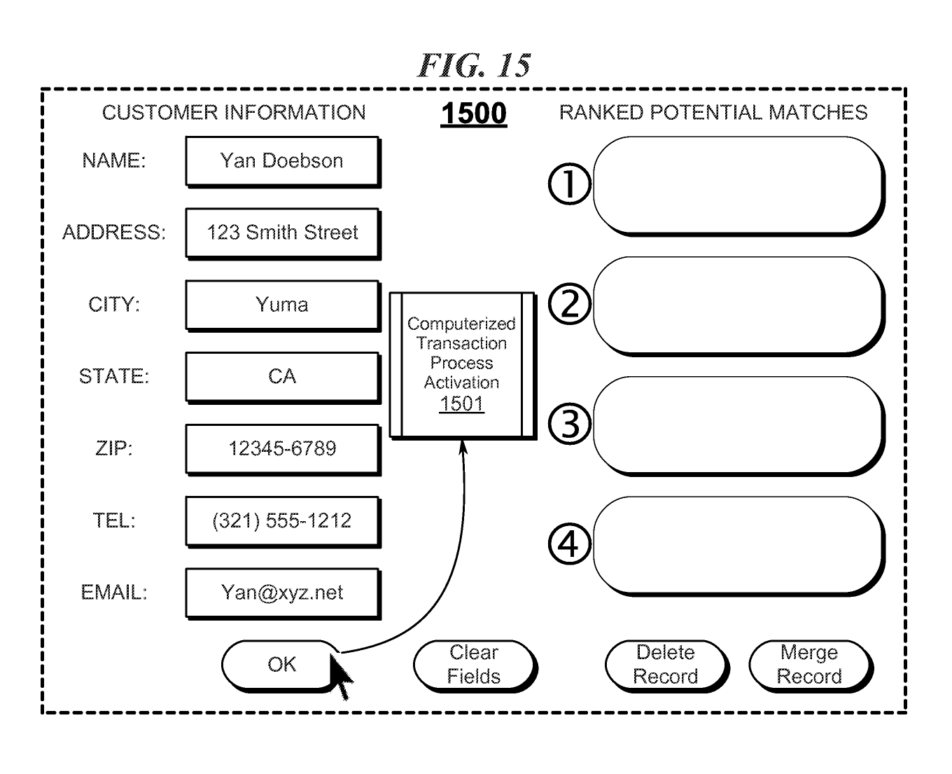

Once the customer context data fields have been filled and a customer index into the customer database has been established, the data entry operator may select the “OK” icon button as generally illustrated in FIG. 15 (1500) to activate a computerized transaction processing system (1501) to complete the transaction with the customer. While many different forms of transactions are envisioned within the scope of the present invention, the use of the present invention is specifically anticipated in the processing of customer financial transactions, with financial transaction being selected from a group consisting of negotiable instrument transactions, check transactions, gifting donations, credit card transactions, debit card transactions, and ACH transactions.

In certain circumstances where the ranked candidate list does not contain the customer in question (as in the case of a “new” customer), the “OK” icon selection in this example may load the customer database with the new customer information as a new customer record. Additionally, it should be noted that the customer context data fields may be modified after population by the ranked candidate list selection. This updated information may then be rewritten to the customer database when the “OK” icon is selected to affect a database update for the current customer record.

### Freeform Data Entry (1600)

The present invention also anticipates a “freeform” data entry methodology wherein the data entry operator may enter any number of words or phrases in a data entry widget (1601) that are then used to heuristically search the customer database for potential matches in a rank selected manner. An example of this implementation is generally illustrated in FIG. 16 (1600), wherein the operator enters a partial list of customer information that is then used to rank and select potential customer records for selection.

It is instructive to note in this example that the heuristic algorithm has detected an “exact” match for the customer event though the customer has phonetically spelled the customer's first name as “John” rather than “Yan.” This has been made possible in this circumstance because the additional “CA” state information indicates additional information that can screen remaining ranked search results to exclude the potential non-matching customer record.

Note that in this exemplary embodiment the search results (1602) displayed may be updated automatically in a continuous manner based on a wide variety of search update dynamics as defined previously. Alarms (visual and/or audible) (1603) may be utilized to indicate that an exact customer match has been found.

### Exemplary Heuristic Data Entry Method

### Overview (1700)

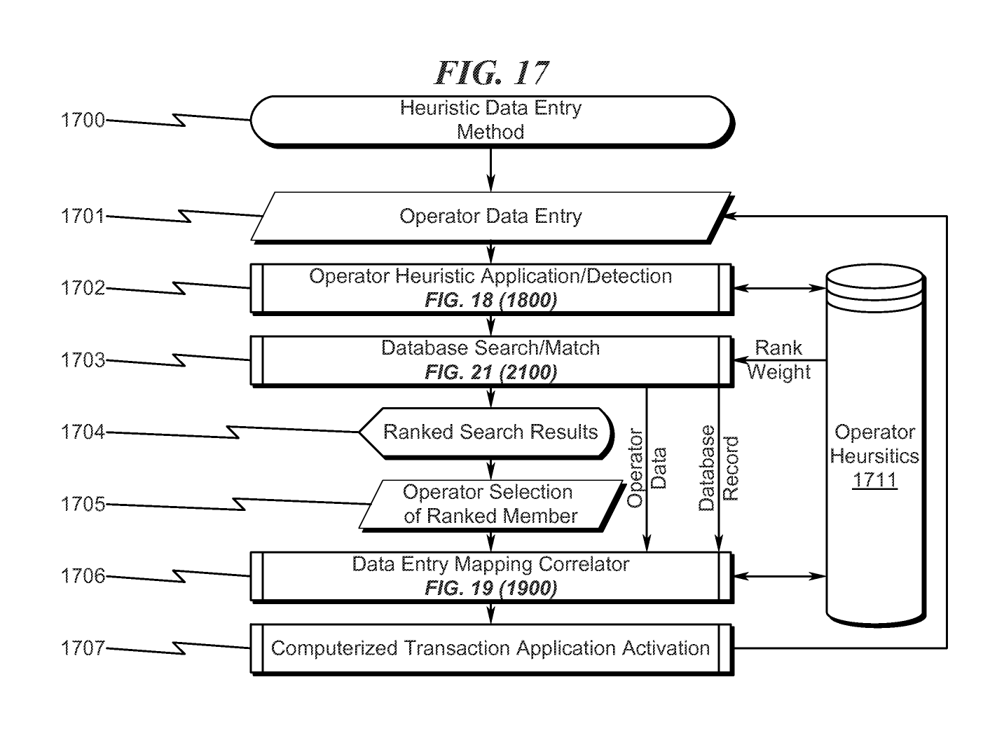

While several methods are anticipated with respect to the present invention, a preferred method embodiment is generally illustrated in FIG. 17 (1700), wherein the method comprises the following steps:
(1) accepting operator data entry (1701);
(2) applying operator heuristics and/or detecting operator error correction patterns to produce a modified operator data entry (1702);
(3) searching/matching the modified operator data entry to a customer database (1703);
(4) ranking search results from step (3) and displaying the ranked search results for operator selection (1704);
(5) accepting operator selection of a member of the displayed ranked search results (1705);
(6) correlating the operator selected member of the ranked search results with the original operator data entry and the resulting database record to form mapping correlations that are stored in a heuristics database for use in a subsequent execution of step (2) (1706);
(7) activating a computerized transaction application using the operator selected member of the ranked search results (1707);
(8) proceeding to step (1) to allow further operator data entry (1708).
   This general method may be modified heavily depending on a number of factors, with rearrangement and/or addition/deletion of steps anticipated by the scope of the present invention. Integration of this and other preferred exemplary embodiment methods in conjunction with a variety of preferred exemplary embodiment systems described herein is anticipated by the overall scope of the present invention.

The general approach for the system/method as described is one of incremental error correction and correlation between both operator data entry manual corrections (via backspace/delete keys, etc.) and correction correlations that occur between a variety of data entry errors or other anomalies that eventually result in a selected member from the ranked search result list.

Since all of this error detection/correction is occurring in real-time, the data entry operator may utilize this feature to create “correction” expressions using the auto-correction feature. For example, the key sequence “teh <BACKSPACE><BACKSPACE><BACKSPACE>he” will be remembered by the heuristics database (1711) and trigger an automatic substitution of this when found in future operator data entry key sequences. This may also permit the operator to incorporate “shorthand” sequences in common data entry operations. For example, the key sequence “W <BACKSPACE>ashington, DC” will permit the substitution of “Washington, D.C.” for every operator data entry of “W” and thus permit dynamic shorthand notation to be incorporated within the data entry operation. Since each operator heuristics database (1711) may be linked to a different data entry operator, each operator may have their own set of profiles on which the shorthand notation is derived.

This same type of learned behavior applies to the use of operator data entry that is correlated to a corresponding member of a ranked search result list. The heuristics database (1711) can incorporate correlation maps that remember the relationship between data entered by the operator and the eventual member of the ranked search result list selected to permit the mapping of data entry to search result to become automatic without additional effort from the data entry operator.

### Exemplary Heuristic Contextual Field Loader (1800)

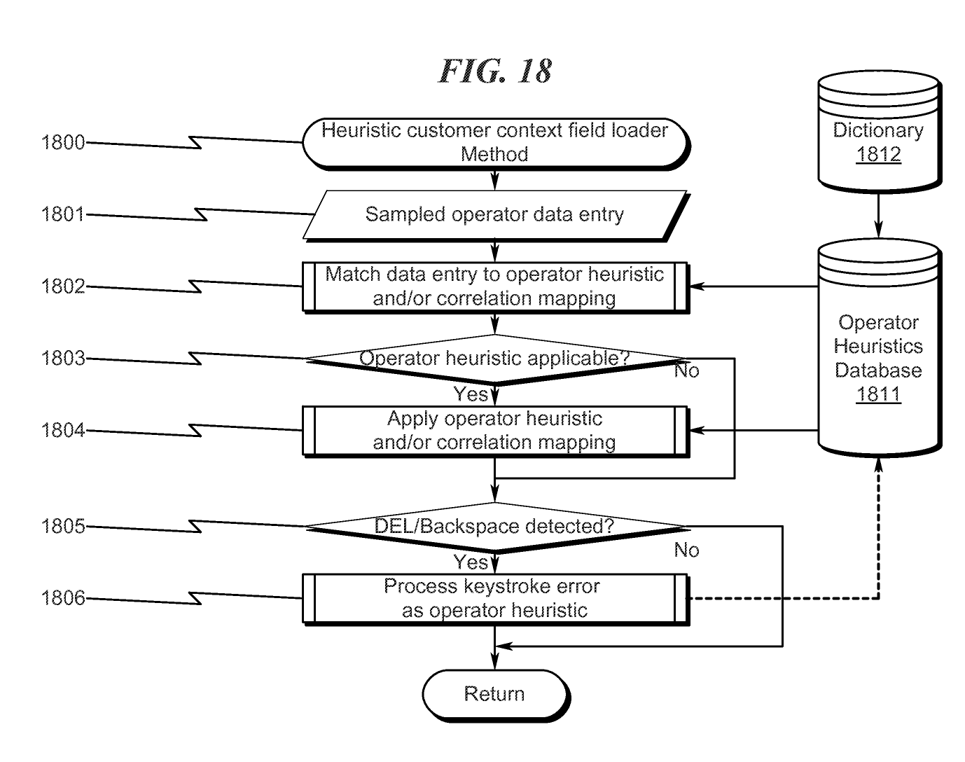

Application and/or detection of operator heuristics may take many forms, but an exemplary preferred embodiment is generally illustrated in FIG. 18 (1800) wherein the method comprises the following steps:
(1) sampling partial operator data entry (1801);
(2) matching the partial data entry to a known operator heuristic and/or correlation mapping from a database (1811) and/or a dictionary (1812) (1802);
(3) if the operator heuristic is not applicable, proceeding to step (5) (1803);
(4) applying the operator heuristic and/or correlation mapping to the operator data entry (1804);
(5) determining if a DEL and/or BACKSPACE key sequence has been detected, and if not, proceeding to step (7) (1805);
(6) processing the keystroke error as a potential operator heuristic and storing it in the operator heuristics database (1806); and
(7) terminating the method (1807).
   This general method may be modified heavily depending on a number of factors, with rearrangement and/or addition/deletion of steps anticipated by the scope of the present invention. Integration of this and other preferred exemplary embodiment methods in conjunction with a variety of preferred exemplary embodiment systems described herein is anticipated by the overall scope of the present invention.

Application of the operator heuristic may involve substitution of operator data entry text and/or filling the customer data entry context fields with information retrieved from the customer database corresponding to a correlation between operator data entry and historically retrieved customer records from the customer database.

### Exemplary Data Entry Mapping Correlator (1900)

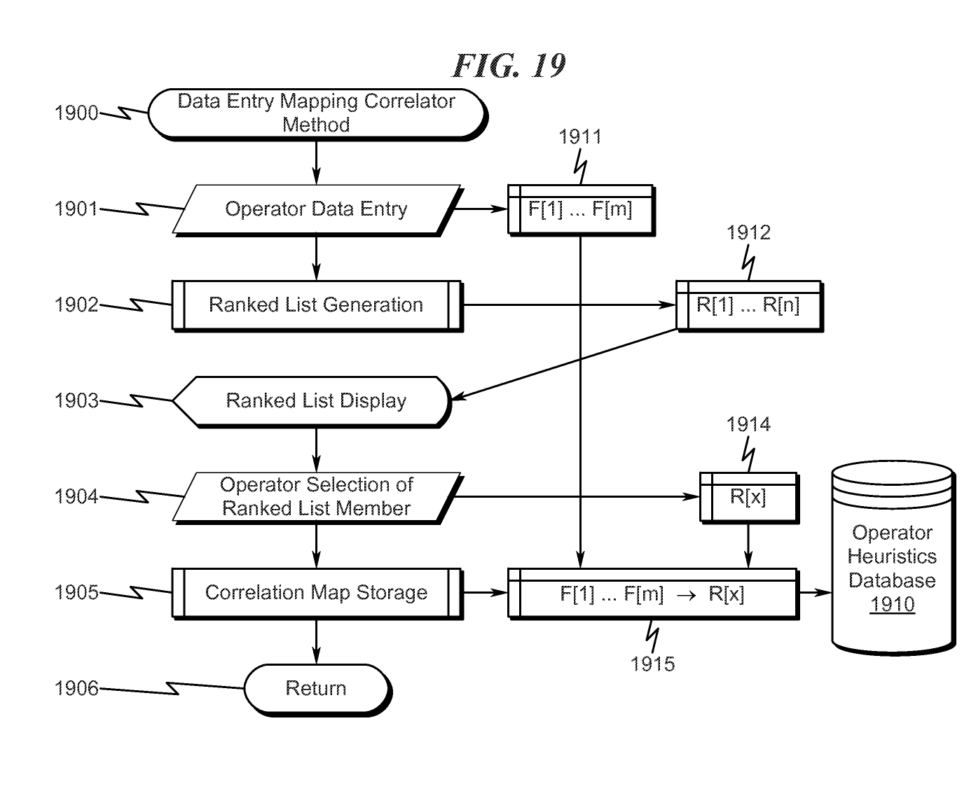

As mentioned previously the present invention may incorporate a correlation map processor to correlate operator data entry and resulting member selection from a ranked list of search results. The results of this correlation may then be used in subsequent operator data entry operations to “fast track” the search solution of the operator data entry. Operator data entry correlation mapping may take many forms, but an exemplary preferred embodiment is generally illustrated in FIG. 19 (1900) wherein the method comprises the following steps:
(1) accepting operator data entry of customer context data fields (1911) comprising a list of enumerated fields (1901);
(2) producing a ranking list vector (1912) from the ranked list of search results for the operator data fields (1902);
(3) displaying the ranked list of search results for operator review (1903);
(4) accepting operator input selection of a particular ranked list entry (1914) (1904);
(5) storing the correlated mapping of the combined data entry fields (1911) and the ranked list selection (1914) as a combined index (1915) into an operator heuristics database (1910) (1905); and
(6) terminating the method (1906).
   This general method may be modified heavily depending on a number of factors, with rearrangement and/or addition/deletion of steps anticipated by the scope of the present invention. Integration of this and other preferred exemplary embodiment methods in conjunction with a variety of preferred exemplary embodiment systems described herein is anticipated by the overall scope of the present invention.

### Exemplary Data Entry Mapping Correlation Heuristic (2000)

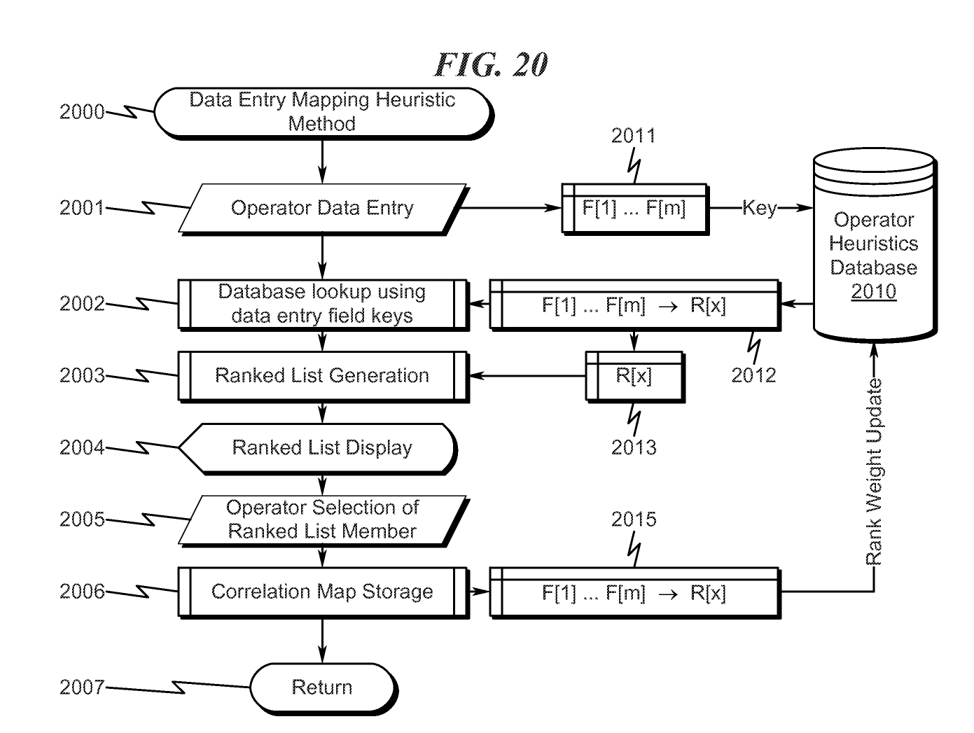

The previously described data entry mapping correlator depicted in FIG. 19 (1900) may be used in conjunction with a data entry mapping correlation heuristic as depicted in FIG. 20 (2000) to affect ranking list substitutions based on historical operator data entry patterns. This permits previous operator data entry operations to “fast track” the search solution of the operator data entry. Operator data entry correlation mapping may take many forms, but an exemplary preferred embodiment is generally illustrated in FIG. 20 (2000) wherein the method comprises the following steps:
(1) accepting operator data entry of customer context data fields (2011) comprising a list of enumerated fields (2001);
(2) performing a operator heuristics database lookup using the enumerated fields (2011) as a key index into an operator heuristics database to retrieve a corresponding mapping transformation (2012) (2002);
(3) producing a ranking list vector from the ranked list of search results for the operator data fields using the correlated result value (2013) from the operator heuristics database as a primary ranked result (2003);
(4) displaying the ranked list of search results for operator review (2004);
(5) accepting operator input selection of a particular ranked list entry (2005);
(6) storing the mapping transformation (2012) as a combined index (2015) into the operator heuristics database (2010) with updated weighting values (2006); and
(7) terminating the method (2007).
   This general method may be modified heavily depending on a number of factors, with rearrangement and/or addition/deletion of steps anticipated by the scope of the present invention. Integration of this and other preferred exemplary embodiment methods in conjunction with a variety of preferred exemplary embodiment systems described herein is anticipated by the overall scope of the present invention.

This exemplary mapping correlation heuristic method permits historical operator data entry to trigger gravitation of the ranked list generation to historically defined terminal search targets in a rapid fashion and thus significantly increases operator data entry performance and efficiency when processing large numbers of customer data entry transactions.

### Exemplary Heuristic Search Matching Architecture

### Search Matching Overview (2100)

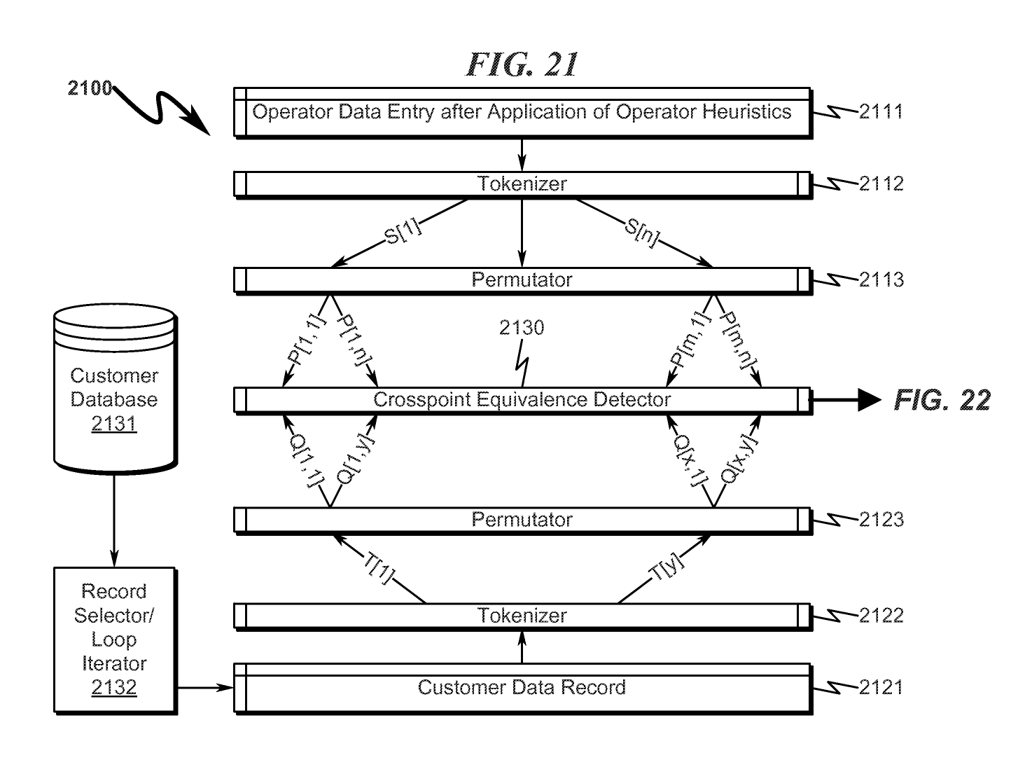

While many heuristic algorithms may be utilized in implementing the present invention, a preferred search matching architecture is generally illustrated in FIG. 21 (2100), wherein operator data entry after application of operator heuristics (2111) is compared against a customer data record (2121) selected from a customer database (2131) after record selection/loop iteration (2132) is performed to extract the target data record (2121). In this exemplary architecture, tokenizers (2112, 2122) are used to tokenize the operator data entry (2111) and customer data record (2121) respectively to generate token lists (S,T) for the source and target matching entities. These token lists (S,T) are then processed by a permutation process (2113, 2123) that applies a variety of data error correction heuristics (examples of which are detailed in the Heuristic Non-Tautological Mapping section herein). The application of these non-tautological transforms generates respective permuted matching vectors (P,Q) that are then compared using a crosspoint equivalence detector (2130) to determine if there are any matches between the permuted operator data (P) and the permuted customer data record (Q). Matches at this level are used to update ranking vectors associated with the correlation between operator data entry tokens and customer data record tokens.

### Crosspoint Equivalence Detector (2200)

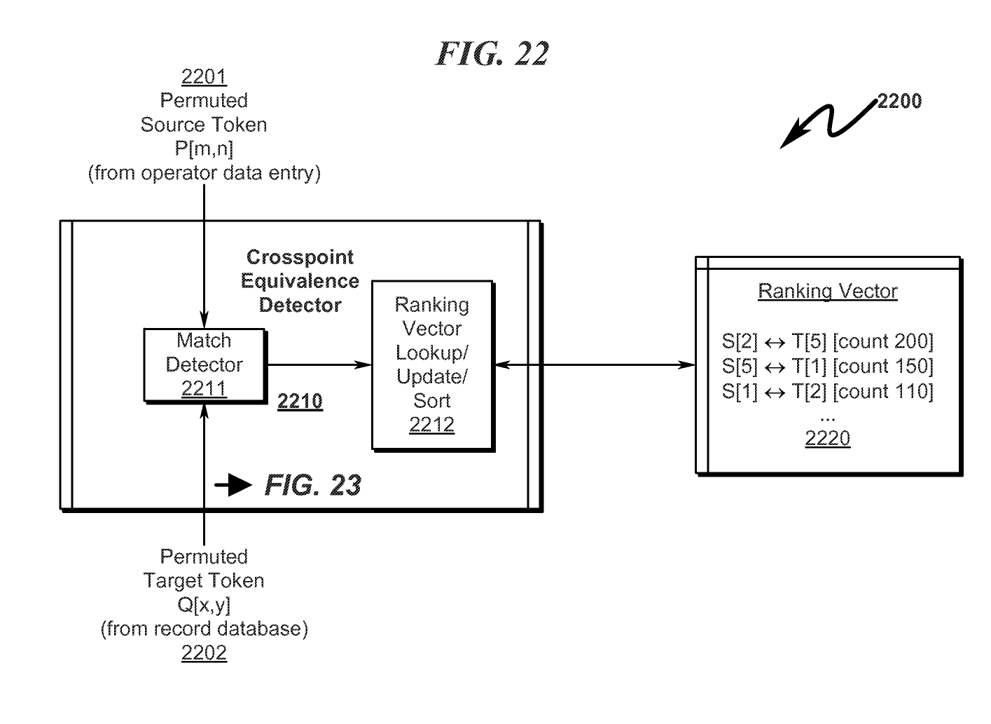

The function of the crosspoint equivalence detector can be more fully understood by inspecting FIG. 22 (2200) wherein an exemplary crosspoint equivalence detector (2210) is depicted that accepts permuted source token data (2201) and compares it to permuted target token data (2202) using a match detector (2211). If a match is detected, a ranking vector lookup/update/sorting procedure is invoked to update the match ranking vector (2220) to indicate what token mappings were detected and in what frequency.

Within this context it is anticipated that the match detector (2211) may also retrieve information regarding the “proximity” of a given token field to another using a variety of algorithms. For example, data entry into a customer “name” field in the customer data context might yield a stronger correlation to the “name” field in the customer data record than that of the “address” field. Proximity functions associated with the match detector may weight a match in some of these circumstances higher than in others.

### Crosspoint Equivalence Method (2300)

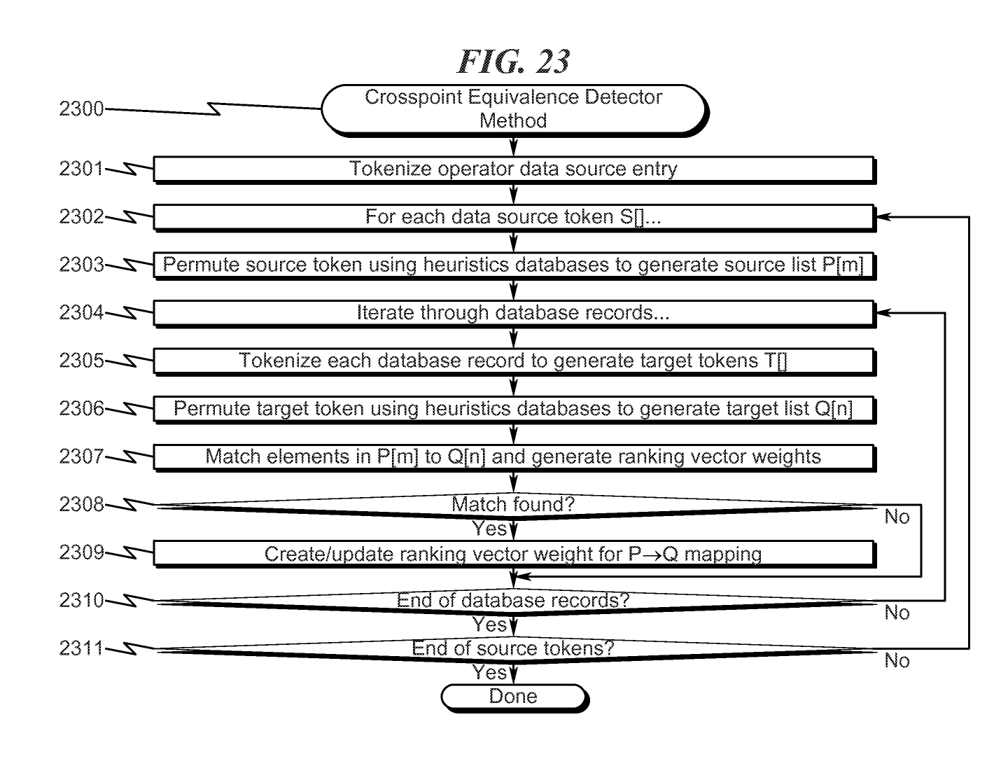

While many techniques may be utilized to implement the crosspoint equivalence functionality described above, as generally illustrated by the flowchart in FIG. 23 (2300) the present invention method anticipates in some preferred embodiments a crosspoint equivalence method comprising:
(1) tokenizing the operator source data entry (2301);
(2) selecting a data source token (2302);
(3) permuting the source token using heuristic databases to generate a source list P[m] (2303);
(4) selecting a database record (2304);
(5) tokenizing the database record to generate target tokens (2305);
(6) permuting the target tokens using heuristics databases to generate a target list Q[n] (2306);
(7) matching elements in P[m] to Q[n] (2307);
(8) if a match is not found, proceeding to step (10) (2308);
(9) creating/updating a ranking vector weight for the P-to-Q mapping (2309);
(10) determining if all database records have been processed, and if not, proceeding to step (4) (2310);
(11) determining if all source tokens have been processed, and if not, proceeding to step (2) (2311).
   This general method may be modified heavily depending on a number of factors, with rearrangement and/or addition/deletion of steps anticipated by the scope of the present invention. Integration of this and other preferred exemplary embodiment methods in conjunction with a variety of preferred exemplary embodiment systems described herein is anticipated by the overall scope of the present invention.

The resulting ranking vector list (2220) generally illustrated in FIG. 22 (2200) indicates which tokens that are matched as well as their weighted frequency and thus the confidence of a particular match between a given operator data input and the customer record retrieved from the customer database.

### System Abstraction (2400)

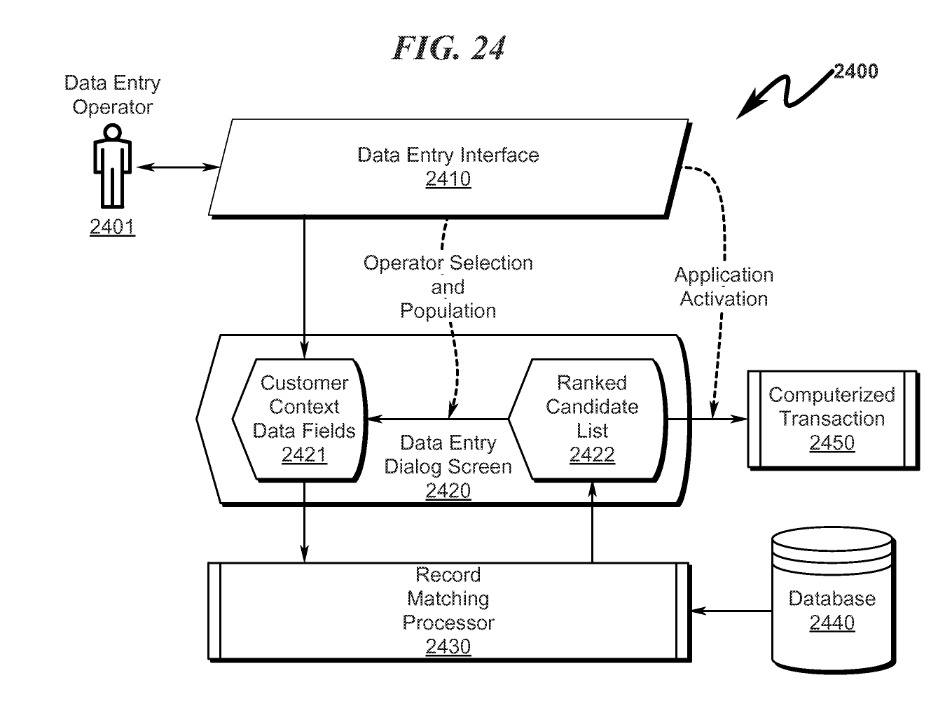

The present invention as detailed above may be abstracted as generally depicted in FIG. 24 (2400), wherein a data entry operator (2401) interacts with a data entry interface (2410) that displays a data entry dialog screen (2420) used to collect data entry from the operator (2401). This data entry dialog screen (2420) comprises one or more customer context data fields (2421) that are continuously inspected in real-time by a record matching processor (2430) that heuristically attempts to match the customer context data fields (2421) against information stored in a database (2440) using non-tautological mapping algorithms. Results of these matching operations are displayed on the data entry dialog screen (2420) in the form of a ranked candidate list (2422) that may be selected by the operator (2401) for population of the customer context data fields (2421) and/or activation of a computerized transaction (2450).

### System Summary

The present invention system anticipates a wide variety of variations in the basic theme of construction, but can be generalized as a heuristic data entry system comprising:
(a) data entry interface;
(b) customer database; and
(c) record matching processor;
wherein
the data entry interface displays a data entry dialog screen, the data entry dialog screen comprising a series of customer context data fields;
the data entry interface permits operator data entry of customer data into one or more of the customer context data fields within the data entry dialog screen;
the customer database comprises customer records comprising customer record data fields associated with the customer context data fields;
the record matching processor continuously matches the customer context data fields to the customer record data fields using a heuristic non-tautological mapping algorithm during the operator data entry to produce a set of potential selection candidates in real-time;
the potential selection candidates are ranked to produce a ranked candidate list;
the ranked candidate list is displayed on the data entry dialog screen;
the data entry interface is configured to permit operator selection of a member of the ranked candidate list; and
the operator selection transfers the customer record data fields to the customer context data fields.

This general system summary may be augmented by the various elements described herein to produce a wide variety of invention embodiments consistent with this overall design description.

### Method Summary

The present invention method anticipates a wide variety of variations in the basic theme of implementation, but can be generalized as a heuristic data entry method comprising:
(1) displaying a data entry dialog screen comprising customer data fields on a data entry interface;
(2) accepting partial customer data as input within the customer data fields on the data entry interface;
(3) continuously matching the customer data fields as the partial customer data is entered against customer record fields within a customer database using a heuristic non-tautological mapping algorithm executed on a record matching processor to produce a set of potential selection candidates in real-time;
(4) ranking the potential selection candidates to form a ranked candidate list;
(5) displaying the ranked candidate list on the data entry dialog screen;
(6) continuously sensing whether a member of the ranked candidate list has been selected by an operator via the data entry interface;
(7) if the member has not been selected, proceeding to step (2);
(8) transferring the customer record fields to the customer data fields in the data entry dialog screen; and
(9) processing a computerized transaction for the customer associated with the customer data fields and proceeding to step (1);
wherein
the steps are performed by one or more computer systems executing software retrieved from a computer readable medium.
   This general method may be modified heavily depending on a number of factors, with rearrangement and/or addition/deletion of steps anticipated by the scope of the present invention. Integration of this and other preferred exemplary embodiment methods in conjunction with a variety of preferred exemplary embodiment systems described herein is anticipated by the overall scope of the present invention.

### System/Method Variations

The present invention anticipates a wide variety of variations in the basic theme of construction. The examples presented previously do not represent the entire scope of possible usages. They are meant to cite a few of the almost limitless possibilities.

This basic system and method may be augmented with a variety of ancillary embodiments, including but not limited to:
An embodiment wherein the operator selected population of the customer context data fields is used as input for the processing of a customer financial transaction, the financial transaction selected from a group consisting of negotiable instrument transactions, check transactions, gifting donations, credit card transactions, debit card transactions, and ACH transactions.
An embodiment wherein the operator selected population of the customer context data fields is used as input for the processing of a product purchase using a web-based electronic commerce order placement processor.
An embodiment wherein the heuristic non-tautological mapping algorithm further comprises correction of data entry errors selected from a group consisting of misspellings, synonym remapping, mispronunciations, key swapping, key insertion, key replication, key omission, key shift offsets, and home key offsets.
An embodiment wherein the heuristic non-tautological mapping algorithm further comprises detection of mapping correlations between the customer data and the operator selection of a member of the ranked candidate list and storage of the mapping correlations in an operator heuristics database.
An embodiment wherein the heuristic non-tautological mapping algorithm further comprises detection of data entry errors and subsequent operator corrections and logging the data entry errors and the subsequent operator corrections in an operator heuristics database.
An embodiment wherein the heuristic non-tautological mapping algorithm further comprises correction of data entry errors using pattern sequences retrieved from an operator heuristics database.
An embodiment wherein the heuristic non-tautological mapping algorithm further comprises remapping of the customer data using mapping correlations retrieved from an operator heuristics database.
An embodiment wherein the data entry interface is embodied in computerized hardware selected from a group consisting of a mobile phone, tablet computer, laptop computer, and desktop computer.
An embodiment wherein the data entry interface and the record matching processor communicate over the Internet.

One skilled in the art will recognize that other embodiments are possible based on combinations of elements taught within the above invention description.

### Generalized Computer Usable Medium

As generally illustrated herein, the system embodiments of the present invention can incorporate a variety of computer readable media that comprise computer usable medium having computer readable code means embodied therein. One skilled in the art will recognize that the software associated with the various processes described herein can be embodied in a wide variety of computer accessible media from which the software is loaded and activated. Pursuant to In re Beauregard, 35 USPQ2d1383 (U.S. Pat. No. 5,710,578), the present invention anticipates and includes this type of computer readable media within the scope of the invention.

### CONCLUSION

A heuristic data entry system/method that integrates data entry search procedures and new data record entry functionality has been disclosed. The system/method allows the data entry operator to enter one of more fields within a dialog menu representing a customer context. As these fields are entered a background process scans a customer database using a heuristic algorithm in an attempt to match the customer context against known customer records using a variety of matching algorithms incorporating non-tautological mapping functions. Customer records matched using these imprecise matching functions are then ranked by relevance and displayed as potential candidates for selection by the operator to complete the remaining customer context. The heuristic algorithms make no assumptions as to the accuracy the data operator entry or the customer record database, thus permitting potential matches between customer context and customer data records to occur with symmetrically non-dominant data accuracy assumptions.

What is claimed is:

1. A heuristic data entry system comprising:
(a) data entry interface;
(b) customer database; and
(c) record matching processor;
wherein
said data entry interface displays a data entry dialog screen, said data entry dialog screen comprising a series of customer context data fields;
said data entry interface permits operator data entry of customer data into one or more of said customer context data fields within said data entry dialog screen;
said customer database comprises customer records comprising customer record data fields associated with said customer context data fields;
said record matching processor continuously matches said customer context data fields to said customer record data fields using a heuristic non-tautological mapping algorithm during said operator data entry to produce a set of potential selection candidates in real-time;
said potential selection candidates are ranked to produce a ranked candidate list;
said ranked candidate list is displayed on said data entry dialog screen;
said data entry interface is configured to permit operator selection of a member of said ranked candidate list; and
said operator selection transfers said customer record data fields to said customer context data fields.

2. The heuristic data entry system of claim 1 wherein said operator selected population of said customer context data fields is used as input for the processing of a customer financial transaction, said financial transaction selected from a group consisting of negotiable instrument transactions, check transactions, gifting donations, credit card transactions, debit card transactions, and ACH transactions.

3. The heuristic data entry system of claim 1 wherein said operator selected population of said customer context data fields is used as input for a web-based electronic commerce order placement processor.

4. The heuristic data entry system of claim 1 wherein said heuristic non-tautological mapping algorithm further comprises correction of data entry errors selected from a group consisting of misspellings, synonym remapping, mispronunciations, key swapping, key insertion, key replication, key omission, key shift offsets, and home key offsets.

5. The heuristic data entry system of claim 1 wherein said heuristic non-tautological mapping algorithm further comprises detection of mapping correlations between said customer data and said operator selection of a member of said ranked candidate list and storage of said mapping correlations in an operator heuristics database.

6. The heuristic data entry system of claim 1 wherein said heuristic non-tautological mapping algorithm further comprises detection of data entry errors and subsequent operator corrections and logging said data entry errors and said subsequent operator corrections in an operator heuristics database.

7. The heuristic data entry system of claim 1 wherein said heuristic non-tautological mapping algorithm further comprises correction of data entry errors using pattern sequences retrieved from an operator heuristics database.

8. The heuristic data entry system of claim 1 wherein said heuristic non-tautological mapping algorithm further comprises remapping of said customer data using mapping correlations retrieved from an operator heuristics database.

9. The heuristic data entry system of claim 1 wherein said data entry interface is embodied in computerized hardware selected from a group consisting of a mobile phone, tablet computer, laptop computer, and desktop computer.

10. The heuristic data entry system of claim 1 wherein said data entry interface and said record matching processor communicate over the Internet.

11. A heuristic data entry method comprising:
(1) displaying a data entry dialog screen comprising customer data fields on a data entry interface;
(2) accepting partial customer data as input within said customer data fields on said data entry interface;
(3) continuously matching said customer data fields as said partial customer data is entered against customer record fields within a customer database using a heuristic non-tautological mapping algorithm executed on a record matching processor to produce a set of potential selection candidates in real-time;
(4) ranking said potential selection candidates to form a ranked candidate list;
(5) displaying said ranked candidate list on said data entry dialog screen;
(6) continuously sensing whether a member of said ranked candidate list has been selected by an operator via said data entry interface;
(7) if said member has not been selected, proceeding to said step (2);
(8) transferring said customer record fields to said customer data fields in said data entry dialog screen; and
(9) processing a computerized transaction for the customer associated with said customer data fields and proceeding to said step (1).

12. The heuristic data entry method of claim 11 wherein said computerized transaction comprises a customer financial transaction, said financial transaction selected from a group consisting of negotiable instrument transactions, check transactions, gifting donations, credit card transactions, debit card transactions, and ACH transactions.

13. The heuristic data entry method of claim 11 wherein said computerized transaction comprises processing a web-based electronic commerce order.

14. The heuristic data entry method of claim 11 wherein said heuristic non-tautological mapping algorithm further comprises correction of data entry errors selected from a group consisting of misspellings, synonym remapping, mispronunciations, key swapping, key insertion, key replication, key omission, key shift offsets, and home key offsets.

15. The heuristic data entry method of claim 11 wherein said heuristic non-tautological mapping algorithm further comprises detection of mapping correlations between said customer data and said operator selection of a member of said ranked candidate list and storage of said mapping correlations in an operator heuristics database.

16. The heuristic data entry method of claim 11 wherein said heuristic non-tautological mapping algorithm further comprises detection of data entry errors and subsequent operator corrections and logging said data entry errors and said subsequent operator corrections in an operator heuristics database.

17. The heuristic data entry method of claim 11 wherein said heuristic non-tautological mapping algorithm further comprises correction of data entry errors using pattern sequences retrieved from an operator heuristics database.

18. The heuristic data entry method of claim 11 wherein said heuristic non-tautological mapping algorithm further comprises remapping of said customer data using mapping correlations retrieved from an operator heuristics database.

19. The heuristic data entry method of claim 11 wherein said data entry interface is embodied in computerized hardware selected from a group consisting of a mobile phone, tablet computer, laptop computer, and desktop computer.

20. The heuristic data entry method of claim 11 wherein said data entry interface and said record matching processor communicate over the Internet.

21. A computer usable medium having computer-readable program code means comprising a heuristic data entry method comprising:
(1) displaying a data entry dialog screen comprising customer data fields on a data entry interface;
(2) accepting partial customer data as input within said customer data fields on said data entry interface;
(3) continuously matching said customer data fields as said partial customer data is entered against customer record fields within a customer database using a heuristic non-tautological mapping algorithm executed on a record matching processor to produce a set of potential selection candidates in real-time;
(4) ranking said potential selection candidates to form a ranked candidate list;
(5) displaying said ranked candidate list on said data entry dialog screen;
(6) continuously sensing whether a member of said ranked candidate list has been selected by an operator via said data entry interface;
(7) if said member has not been selected, proceeding to said step (2);
(8) transferring said customer record fields to said customer data fields in said data entry dialog screen; and
(9) processing a computerized transaction for the customer associated with said customer data fields and proceeding to said step (1).

22. The computer usable medium of claim 21 wherein said computerized transaction comprises a customer financial transaction, said financial transaction selected from a group consisting of negotiable instrument transactions, check transactions, gifting donations, credit card transactions, debit card transactions, and ACH transactions.

23. The computer usable medium of claim 21 wherein said computerized transaction comprises processing a web-based electronic commerce order.

24. The computer usable medium of claim 21 wherein said heuristic non-tautological mapping algorithm further comprises correction of data entry errors selected from a group consisting of misspellings, synonym remapping, mispronunciations, key swapping, key insertion, key replication, key omission, key shift offsets, and home key offsets.

25. The computer usable medium of claim 21 wherein said heuristic non-tautological mapping algorithm further comprises detection of mapping correlations between said customer data and said operator selection of a member of said ranked candidate list and storage of said mapping correlations in an operator heuristics database.

26. The computer usable medium of claim 21 wherein said heuristic non-tautological mapping algorithm further comprises detection of data entry errors and subsequent operator corrections and logging said data entry errors and said subsequent operator corrections in an operator heuristics database.

27. The computer usable medium of claim 21 wherein said heuristic non-tautological mapping algorithm further comprises correction of data entry errors using pattern sequences retrieved from an operator heuristics database.

28. The computer usable medium of claim 21 wherein said heuristic non-tautological mapping algorithm further comprises remapping of said customer data using mapping correlations retrieved from an operator heuristics database.

29. The computer usable medium of claim 21 wherein said data entry interface is embodied in computerized hardware selected from a group consisting of a mobile phone, tablet computer, laptop computer, and desktop computer.

30. The computer usable medium of claim 21 wherein said data entry interface and said record matching processor communicate over the Internet.
